(19) United States
(12) Patent Application Publication
(10) Pub. No.: US 2006/0222235 A1
(43) Pub. Date: Oct. 5, 2006

(54) Defect inspection method

(76) Inventor: Kenshi Kanegae, Osaka (JP)

Correspondence Address: MCDERMOTT WILL & EMERY LLP, 600 13TH STREET, N.W., WASHINGTON, DC, 20005-3096, US

(21) Appl. No.: 11/391,374

(22) Filed: Mar. 29, 2006

(30) Foreign Application Priority Data
Mar. 29, 2005 (JP) 2005-094743

(51) Int. Cl. G06K 9/00

(52) U.S. Cl. 382/145

(57) ABSTRACT

By irradiating a substrate to be inspected with an energy beam, the energy beam reflected from the substrate to be inspected is obtained as a digital image signal. When the intensity of the obtained digital image signal exceeds a threshold, the digital image signal is detected as a defect. The threshold is set based on the maximum intensity of a noise signal included in the digital image signal.

### BACKGROUND OF THE INVENTION

The present invention relates to a defect inspection method which uses an energy beam such as an electron beam, a light beam, or an X-ray beam to obtain an image representing a physical property such as charged particles, a reflected beam, or a scattered beam from an inspection target such as a semiconductor wafer formed with a circuit pattern, a circuit board, a liquid crystal board, a photomask, a magnetic disk head, an optical disk, or a hard disk and inspects a defect in the inspection target by using the image. More particularly, the present invention relates to a defect inspection method using an algorithm for determining the presence or absence of a defect by setting a threshold to an image signal or a differential image signal.

With the recent growing trend toward the production of a more miniaturized electronic device for improved performance and reduced chip cost or a larger-area image device for satisfying customer needs or product differentiation, defects caused by a foreign material or the like in device fabrication have greatly affected the yield and quality of a product.

However, as the diameter of an inspection spot has been reduced with the miniaturization of a pattern or an inspection area has increased, an inspection time has increased and a throughput has lowered accordingly. In addition, it has become difficult to obtain a clear image with a high contrast due to the reduced diameter of the inspection spot so that the ratio between a defect detection signal and a noise signal (S/N ratio) has lowered. As a result, a problem has occurred in which the setting of a threshold for defect detection becomes difficult and the adjustment of an inspection apparatus requires enormous time or the like.

Consequently, it has become necessary to reduce the diameter of the inspection spot and increase inspection sensitivity in response to the miniaturized pattern and increase an inspection speed in response to the increased inspection area.

For example, Patent Document 1 discloses a method for setting an inspection threshold for a pattern comparison inspection apparatus.

In an inspection based on a comparison between pattern images, the difference between an image to be inspected (hereinafter referred to as an inspection image) and an image with which the inspection image is compared (hereinafter referred to as a reference image) is determined. When the difference (a differential image) therebetween is not less than a threshold, the inspection image is determined to be defective. When the difference therebetween is less than the threshold, the inspection image is determined to be normal. That is, a trade-off relationship is observed between the threshold and the inspection sensitivity such that the inspection sensitivity lowers when the threshold is increased and the inspection sensitivity increases when the threshold is reduced. The threshold serving as a criterion for determining a defect is an important parameter which determines inspection performance. Even when the inspection target has no pattern, a defect is detected by performing an image comparison between a region to be inspected and an adjacent region thereof or by sensing a change in the intensity of an unprocessed data signal which has not undergone the image comparison. In either case, it is necessary to perform threshold setting in accordance with an inspection target.

Patent Document 1 discloses a method which performs threshold adjustment during an inspection to suppress the detection of a pseudo defect (a non-defect which has been erroneously detected as a defect, such as background noise resulting from color unevenness in an inspection target or the like) due to an excessively low threshold and thereby eliminates the overflow of an inspection apparatus. Specifically, the disclosed method determines the density of defects during the inspection, while performing the inspection by setting an initial threshold prior to the inspection and performs, when the defect density exceeds a predetermined value, an inspection again by increasing the threshold and thereby reducing the inspection sensitivity.

On the other hand, Patent Document 2 discloses, e.g., an inspection apparatus provided with a plurality of detection systems for a reduced inspection time. In the inspection apparatus shown in Patent Document 2, tone correction and threshold correction are performed by using a noise signal to eliminate the difference between the plurality of detection systems. The noise signal is obtained by performing an inspection using an inspection target without a pattern or the like. Linear approximation is performed based on the darkness level of each of the detection systems and the peak value of the noise signal thereof and the tone correction is performed such that the lines obtained for the individual detection systems have the same gradients and the same intercepts. For the threshold adjustment, a threshold is set for each of the detection systems through the addition of an empirical offset value (dd) to the variation range (standard deviation σ) of the noise signal in each of the detection systems or a constant threshold is set for each of the detection systems through the addition of the empirical offset (dd) by using a variation range (σMax) which maximizes the variation range of the noise signal in each of the detection systems.

For the threshold adjustment when an actual inspection target is to be inspected, thresholds are finely set at several levels prior to inspections, which are then performed with respect to a large region to be inspected, so that a threshold assumed to be optimal is selected through the comparison between the results of the inspections.

[Patent Document 1] Japanese Laid-Open Patent Publication No. 2002-228606

[Patent Document 2] Japanese Laid-Open Patent Publication No. 2000-67797

### SUMMARY OF THE INVENTION

However, because the threshold setting method disclosed in Patent Document 1 uses the technique of increasing the threshold when the defect density exceeds a given value, the problem occurs that an actual defect is missed when the threshold is increased. When the increment of the threshold is small, several preparatory inspections become necessary till the setting of the threshold satisfies requirements so that inspection requires tremendous time. When the increment of the threshold is large, on the other hand, the possibility of missing an intrinsic defect is high. In short, the threshold setting method disclosed in Patent Document 1 has had the problem of increased variations in evaluation and the problem of enormous time required to adjust the increment of the threshold for the setting thereof and an initial threshold value.

Since the threshold correction method for the inspection apparatus having the plurality of detection systems disclosed in Patent Document 2 sets the threshold by adding the empirical offset (dd) to the variation range (standard deviation σ) of the noise signal in each of the detection systems, threshold adjustment becomes insufficient for the maximum value of the noise signal associated with actual defect detection. Accordingly, an error between the maximum values of the noise signals in the individual detection systems is large, i.e., variations occur in the differences between the thresholds for defect determination and the maximum values of the noise signals so that the erroneous detection of a defect and the missing of a defect each resulting from insufficient accuracy of threshold adjustment occur. In the case of using a complicated noise signal having a plurality of peaks, in particular, an error between the variation ranges of the noise signals is increased to disable proper threshold adjustment. As a result, the erroneous detection of a defect and the missing of a defect frequently occur.

Although an inspection focus has not particularly been mentioned in each of Patent Documents 1 and 2, focus adjustment is difficult because a pattern serving as an inspection target has been increasingly miniaturized. As a result, a blurry image resulting from a focus shift has become conspicuous to cause the problem of the missing of a defect.

Although a method for focus adjustment for each of the detection systems has not particularly been mentioned in Patent Document 2, a blurry image due to insufficient accuracy of focus correction in each of the detection systems has become conspicuous to cause the problem of the missing of a defect.

In addition, each of the defect inspection apparatus and the defect inspection systems disclosed in Patent Documents 1 and 2 has neither a defect detection signal in a database for storing defect information nor an index indicating the validity of a threshold. As a result, it is necessary to repeatedly perform inspections several times, while varying the threshold, for the adjustment of the threshold to an optimal value. In an inspection using an electron beam, therefore, a conspicuous image change has been caused particularly by charging up and the problem that the inspection cannot be performed any more has been encountered.

In view of the foregoing, it is therefore an object of the present invention to allow parameters such as a defect detection threshold and a defect detection focus in a defect inspection to be set with high accuracy in a short time.

To attain the object, a first defect inspection method according to the present invention comprises the steps of: irradiating a substrate to be inspected with an energy beam to obtain the energy beam reflected from the substrate to be inspected as a digital image signal; and detecting the digital image signal as a defect when an intensity of the obtained digital image signal exceeds a threshold, wherein the threshold is set based on a maximum intensity of a noise signal included in the digital image signal.

In accordance with the first defect inspection method, even when the defect density in the substrate to be inspected is particularly low or when the ratio between a defect signal and the noise signal is particularly low, the threshold for defect detection can be set with high accuracy in a short time based on the maximum intensity of the noise signal from the substrate to be inspected by evaluating the noise signal including color unevenness in the substrate to be inspected. As a result, it becomes possible to minimize the possibilities of the erroneous detection of a defect and the missing of a defect and reduce inspection variations. It also becomes possible to perform high-accuracy and short-time correction for the adjustment of the sensitivity of a detection system, which has conventionally required enormous time.

Preferably, the first defect inspection method further comprises the steps of: obtaining the intensity of the noise signal from a specified inspected region of the substrate to be inspected as a discrimination tone; determining a number of the noise signals that have been detected for the discrimination tone; calculating a cumulative number of the detected noise signals by integrating the number of the detected noise signals with the discrimination tone; performing logarithmic transformation with respect to the cumulative number of the detected noise signals by using a normal distribution characteristic of the noise signal and calculating a cube root of the logarithmically transformed cumulative number of the detected noise signals as a logarithmically transformed cube-root cumulative number of the detected noise signals; and calculating a maximum value of the discrimination tone with which the cumulative number of the detected noise signals is less than 1 based on a linear characteristic of the logarithmically transformed cube-root cumulative number of the detected noise signals for the discrimination tone and setting the calculated value to the threshold.

Even when the cumulative number of detected noise signals from the substrate to be inspected is small and therefore it is difficult to set the threshold by using actual defects, the arrangement allows high-accuracy setting of a proper threshold in accordance with the substrate to be inspected. Accordingly, it becomes possible to perform a defect inspection in which the erroneous detection of a defect and the missing of a defect are minimized. In addition, a time required for threshold setting can significantly be reduced and threshold setting can be automated by using a computer and software.

In this case, when a defect inspection apparatus having a plurality of detection systems is used, i.e., when the digital image signal is obtained from the substrate to be inspected by each of the plurality of detection systems, the number of the detected noise signals, the cumulative number of the detected noise signals, the logarithmically transformed cube-root cumulative number of the detected noise signals, and the threshold are calculated for each of the plurality of detection systems and an offset value is preferably set to each of the thresholds such that the respective thresholds calculated for the plurality of detection systems have the same values, while a coefficient is preferably set to each of gradients of straight lines representing respective linear characteristics of the logarithmically transformed cube-root cumulative number of the detected noise signals calculated for the plurality of detection systems for the discrimination tone such that the straight lines have the same gradients. Even when the defect inspection apparatus having the plurality of detection systems is used, the arrangement allows threshold correction to be performed such that defect detection thresholds for the individual detection systems have the same values. Accordingly, the defect detection threshold of each of the detection systems can be maintained constant and proper with high accuracy.

In this case, the digital image signal is preferably obtained for each value of a parameter of the energy beam by varying the value of the parameter, the number of the detected noise signals, the cumulative number of the detected noise signals, the logarithmically transformed cube-root cumulative number of the detected noise signals, and the threshold as the maximum discrimination tone with which the cumulative number of the detected noise signals is less than 1 are preferably calculated for each value of the parameter, and the value of the parameter which allows the threshold to be maximized is preferably determined based on the threshold calculated for each value of the parameter.

Compared with the prior art technology that has performed the setting of a parameter such as a focus by using the image contrast of the substrate to be inspected, the arrangement allows high-accuracy setting of a proper value of the parameter in accordance with the substrate to be inspected and thereby allows a defect inspection in which the erroneous detection of a defect and the missing of a defect are minimized. In addition, a time required for parameter setting can significantly be reduced and parameter setting can be automated by using a computer and software. In the case where a defect inspection apparatus having a plurality of detection systems is used, i.e., where a digital image signal is obtained from the same substrate to be inspected for each value of the parameter by each of the plurality of detection systems, the number of the detected noise signals, the cumulative number of the detected noise signals, the logarithmically transformed cube-root cumulative number of the detected noise signals, and the threshold as the maximum discrimination tone with which the cumulative number of the detected noise signals is less than 1 are preferably calculated for each value of the parameter for each of the plurality of detection systems, the value of the parameter which allows the threshold to be maximized is preferably calculated for each of the plurality of detection systems, and an offset value is preferably set to each of the values of the parameter such that the parameter which allows the threshold to be maximized that has been calculated for each of the plurality of detection systems has the same value. Even when the defect inspection apparatus having the plurality of detection systems is used, the arrangement allows parameter correction to be performed such that each of the detection systems has the same value of a parameter such as a focus. Accordingly, the value of the parameter of each of the detection systems can be maintained constant and proper with high accuracy. When the energy beam is a light beam, the parameter may be a focus or a wavelength and, when the energy beam is an electron beam, the parameter may be a focus provided by an electronic lens, an acceleration energy, or an energization current.

A second defect inspection method according to the present invention comprises the steps of: irradiating a substrate to be inspected with an energy beam to obtain the energy beam reflected from the substrate to be inspected as a digital image signal; and detecting the digital image signal as a defect when an intensity of the obtained digital image signal exceeds a threshold, the defect inspection method further comprising: a sampling inspection step of performing a sampling inspection with respect to a specified inspected region of the substrate to be inspected and setting the threshold based on a maximum intensity of a noise signal included in the digital image signal obtained as a result of the sampling inspection; and a main inspection step of performing a main inspection with respect to the substrate to be inspected and detecting the digital image signal as a defect when the intensity of the digital image signal obtained as a result of the main inspection exceeds the threshold set in the sampling inspection step.

In accordance with the second inspection method, even when the defect density in the substrate to be inspected is particularly low or when the ratio between a defect signal and the noise signal is particularly low, the defect detection threshold can be set with high accuracy in a short time based on the maximum intensity of the noise signal from the substrate to be inspected by evaluating the noise signal including color unevenness in the substrate to be inspected. As a result, it becomes possible to minimize the possibilities of the erroneous detection of a defect and the missing of a defect.

In the second defect inspection method, when a pattern exists on the substrate to be inspected, the specified inspected region preferably impartially includes the pattern, a ratio of an area of the specified inspected region to an area of the entire inspected region of the substrate to be inspected is preferably not less than 1/100 and not more than 1/10, and the specified inspected region is preferably evenly distributed over the entire inspected region.

The arrangement allows high-accuracy and short-time setting of the defect detection threshold. In this case, the specified inspected region may be set in a striped configuration or in an array-like configuration.

In the second defect inspection method, a S/N ratio between the intensity of the digital image signal detected as the defect in the main inspection step and the maximum intensity of the noise signal is preferably calculated such that the threshold is set again based on the calculated S/N ratio and a defect is preferably extracted again by using the digital image signal obtained by the main inspection and the threshold set again without newly performing the main inspection.

The arrangement allows the checking of the S/N ratio as an index of the authenticity of a defect and thereby allows the defect detection threshold to be set again with high accuracy based on the S/N ratio. If the S/N ratio obtained by one main inspection is recorded on a per defect basis in a database, the checking of the usability of inspection data and the screening of a defect can easily be performed by virtually varying the threshold without performing the main inspection again. It is also possible to perform the defect inspection according to the present invention after performing a specified processing step with respect to the same substrate to be inspected, calculate the S/N ratio between a defect detection signal and a noise signal, and record the S/N ratio in the database on a per defect basis. Alternatively, it is also possible to calculate the S/N ratios of defects detected in the defect inspection of a plurality of substrates to be inspected each having the same structure and determine the authenticity of each of the detected defects based on the difference between the respective S/N ratios of the individual substrates to be inspected.

In the second defect inspection method, a S/N ratio between the intensity of the digital image signal detected as the defect in the main inspection step and the maximum intensity of the noise signal is calculated and the calculated S/N ratio is preferably displayed for each of the defects detected in the main inspection step during the main inspection step or after a completion thereof, a S/N ratio between each of a minimum value of the intensity of the digital image signal detected as the defect in the main inspection step, a mean value thereof, and a maximum value thereof and the maximum intensity of the noise signal is calculated and each of the calculated S/N ratios is preferably displayed during the main inspection step or after the completion thereof, or a correlation between a number of the detected digital image signals each detected as the defect in the main inspection step, a cumulative number of the detected digital image signals, or a logarithmically transformed cube-root cumulative number of the detected digital image signals and the intensity of the digital image signal is preferably displayed during the main inspection step or after the completion thereof.

The arrangement allows the difference between the noise signal and the defect signal to be recognized even during the inspection and allows real-time checking of the authenticity of the inspection result. In short, the erroneous inspection of a defect resulting from noise can promptly be sensed.

Preferably, the second defect inspection method further comprises the step of: before the main inspection step, preliminarily extracting a region in which a S/N ratio between the intensity of the digital image signal and the maximum intensity of the noise signal is lower than a specified value and setting the extracted region as an excluded region, wherein the main inspection step includes performing the main inspection with respect to a remaining region other than the excluded region in the substrate to be inspected.

The arrangement allows preliminary extraction of a region including a group of patterns in which the erroneous detection of a defect is likely to occur and thereby allows the extracted region to be excluded from the region to be inspected. Consequently, it becomes possible to set a high S/N ratio (i.e., a low defect detection threshold) to the other region and thereby increase the sensitivity of the defect detection.

In the second defect inspection method, the main inspection step is preferably performed a plurality of times, a S/N ratio between the intensity of the digital image signal detected as the defect in each of the main inspection steps and the maximum intensity of the noise signal is preferably calculated, and a comparison is preferably made between the respective S/N ratios that have been calculated for an arbitrary defect in the individual main inspection steps such that one or more of the main inspection steps in each of which the S/N ratio is relatively high are extracted.

The arrangement allows easy extraction of the main inspection step which exhibits a high defect detection sensitivity to an arbitrary defect. To sum up, in the setting of a threshold in accordance with a defect inspection method using a single or a plurality of detection systems, even when the defect density in the substrate to be inspected is particularly low or when the ratio between a defect signal and the noise signal is particularly low, the present invention allows the defect detection threshold to be set with high accuracy in a short time based on the maximum intensity of the noise signal by evaluating the noise signal including color unevenness in the substrate to be inspected and the like. In addition, the present invention also allows high-accuracy and short-time correction to be performed for the adjustment of the sensitivity of a detection system that has conventionally required an enormous amount of time.

Thus, the present invention relates to a method for performing a defect inspection by setting a defect detection threshold and is applicable to inspections in general such as a shipment visual inspection and a step tracking inspection. Specifically, the present invention is applicable to a reticle inspection, a wafer inspection, a hard disk surface inspection, a white spot inspection (for a liquid crystal panel, a CCD, or the like), or the like. When applied to the pattern inspection of an inspection target having a pattern or the particle inspection of an inspection target not having a pattern, in particular, the present invention achieves the effect of allowing high-accuracy and short-time setting of a defect detection threshold and is therefore extremely useful.

### BRIEF DESCRIPTION OF THE DRAWINGS

FIG. 1 is a flow chart of a defect inspection method according to a first embodiment of the present invention;

FIGS. 2A to 2F are views for illustrating the individual steps (when data decomposition is unnecessary) of the process flow shown in FIG. 1;

FIGS. 3A to 3F are views showing an example of the setting of a sampling region in a defect inspection method according to each of the first to fifth embodiments of the present invention;

FIGS. 4A to 4F are views for illustrating the individual steps (when data decomposition is necessary) of the process flow shown in FIG. 1;

FIG. 5 is a view for illustrating the data decomposition in the defect inspection method according to the first embodiment;

FIG. 6 is a view for illustrating the data decomposition in the defect inspection method according to the first embodiment;

FIG. 7 is a flow chart of a defect inspection method according to a second embodiment of the present invention;

FIGS. 8A to 8E are views for illustrating the individual steps of the process flow shown in FIG. 7;

FIG. 9 is a view for illustrating one of the steps of the process flow shown in FIG. 7;

FIG. 10 is a flow chart of a defect inspection method according to a third embodiment of the present invention;

FIGS. 11A to 11E are views for illustrating the individual steps of the process flow shown in FIG. 10;

FIG. 12 is a flow chart of a defect inspection method according to a fourth embodiment of the present invention;

FIG. 13 is view showing a schematic structure of a defect inspection system according to a fifth embodiment of the present invention and a data flow therein;

FIG. 14 is a flow chart of a defect inspection method according to the fifth embodiment of the present invention;

FIGS. 15A and 15B are views for illustrating a method for evaluating an S/N ratio in the defect inspection method according to the fifth embodiment;

FIG. 16 is a view for illustrating an inspection operation in the defect inspection method according to the fifth embodiment; and

FIG. 17 is a view for illustrating the inspection operation in the defect inspection method according to the fifth embodiment.

### DETAILED DESCRIPTION OF THE INVENTION

### Embodiment 1

Referring to the drawings, a defect inspection method according to a first embodiment of the present invention will be described with reference to the drawings.

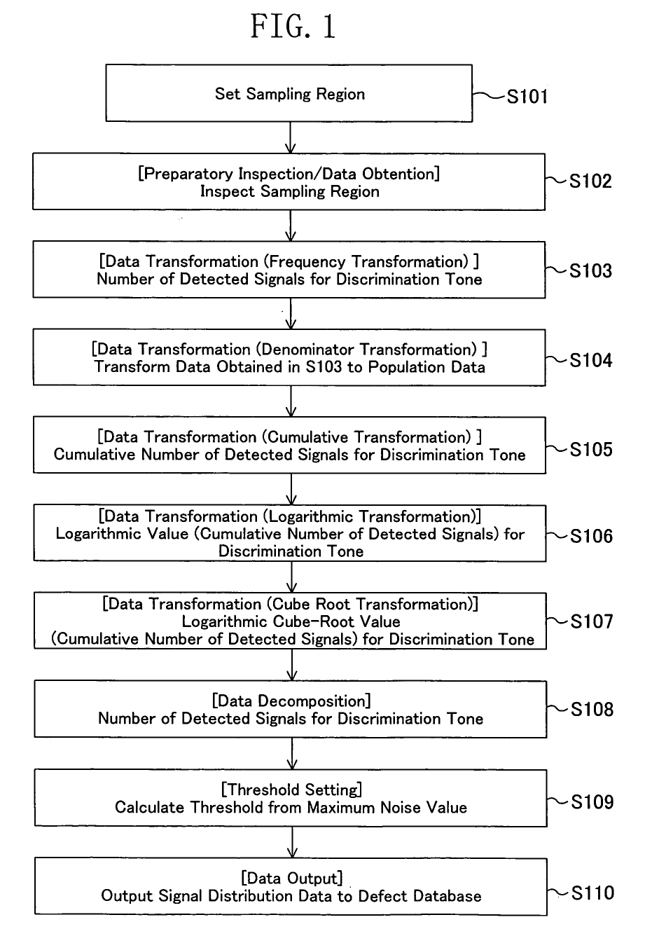

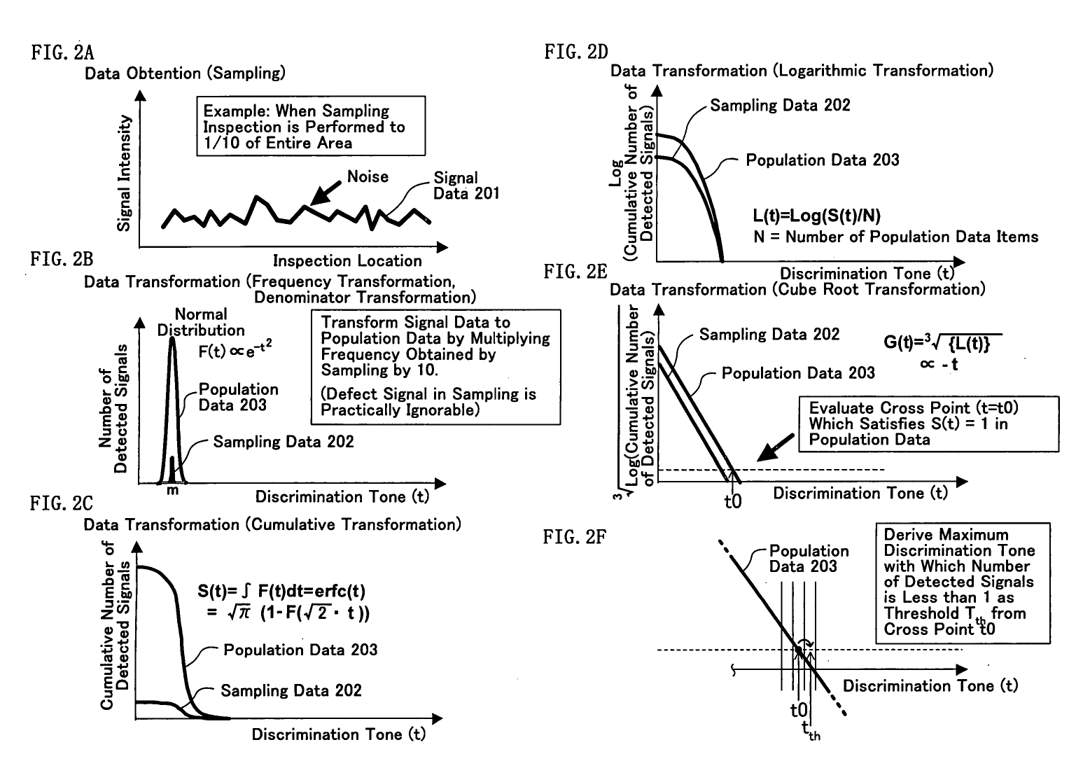

FIG. 1 shows a process flow of the defect inspection method according to the first embodiment, specifically a method for determining a threshold for defect detection by noise evaluation according to the present invention. FIGS. 2A to 2F are views for illustrating the individual steps of the process flow (particularly a signal transformation method in accordance with a noise evaluation algorithm) shown in FIG. 1. Specifically, FIG. 2A corresponds to Step S102 of FIG. 1, FIG. 2B corresponds to Steps S103 and S104 of FIG. 1, FIG. 2C corresponds to Step S105 of FIG. 1, FIG. 2D corresponds to Step S106 of FIG. 1, FIG. 2E corresponds to Step S107 of FIG. 1, and FIG. 2F corresponds to Step S109 of FIG. 1. In the present embodiment, an image signal is retrieved from a defect inspection apparatus, noise evaluation is performed with respect to the retrieved signal, and a threshold value is determined based on the result of the noise evaluation in the process steps shown in FIGS. 2A to 2F.

First, in Step S101, the setting of a sampling region is performed. This is a process for reducing a region to be inspected in an actual inspection target (e.g., a substrate). By reducing the region to be inspected, it becomes possible to minimize an actual defect signal included in data processed by a threshold determining method using the noise evaluation algorithm which will be described below and thereby precisely evaluate noise. By reducing the region to be inspected, it becomes also possible to promptly perform a process associated with threshold determination.

As will be described later, the present embodiment allows high-accuracy setting of a threshold in accordance with an inspection target even when the denominator (total number) of the number of defects detected by a defect inspection is small. Since it is unnecessary to detect a defect from the inspection target during the setting of the threshold, the threshold can be set more reliably and the threshold setting can easily be automated (at a higher speed).

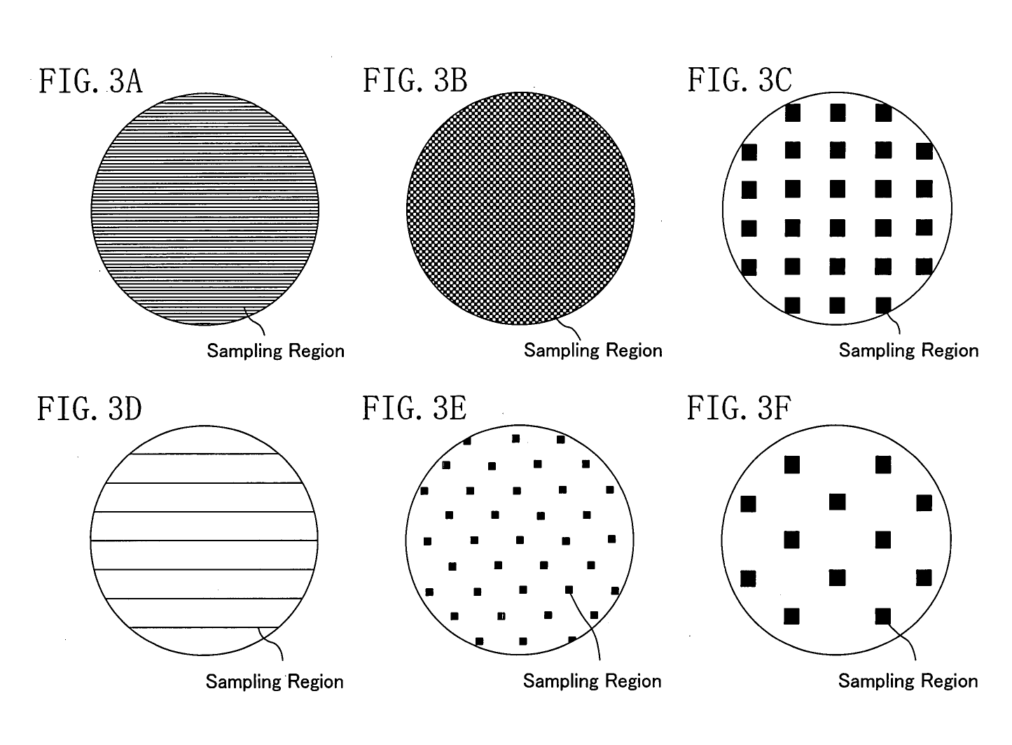

FIGS. 3A to 3F show an example of the setting of the sampling region on a wafer as the inspection target. In the present embodiment, to allow high-accuracy and short-time setting of the threshold for defect detection, the ratio (hereinafter referred to as a sampling ratio Rs) of the area of the sampling region to the total area of the region to be inspected is preferably set to a value not less than about 1% and not more than about 10%. FIGS. 3A to 3C show an example of the setting of a sampling region with a high sampling ratio Rs. FIGS. 3D to 3F show an example of the setting of a sampling region with a low sampling ratio Rs.

In the present embodiment, the result of noise evaluation performed by inspecting the sampling region is regarded as the result of noise evaluation performed with respect to the entire region to be inspected in consideration of the sampling ratio Rs. The sampling region is set impartially to the entire region to be inspected. This enables high-accuracy reconstruction of a noise signal throughout the entire area of the region to be inspected irrespective of a reduction in the area of the region to be expected resulting from the setting of the sampling region. As a result, it becomes possible to determine the maximum value of noise (maximum intensity of the noise signal) with high accuracy and handle signal variations due to color unevenness in the sampling region as noise signals.

Specifically, as shown in FIGS. 3A to 3F, the sampling region can be set in a striped configuration or in an array-like configuration. In the case where no pattern exists on an inspection target, it is effective to set the sampling region in a striped configuration as shown in FIG. 3A or 3D or set small sampling regions in an array-like configuration as shown in FIG. 3B or 3E. In the case where a pattern exists on the inspection target, it is preferable to set the sampling region in an array-like configuration in accordance with the repetitive units of a pattern (e.g., repetitive units such as chip regions or the like), as shown in FIG. 3C or 3F. In other words, it is desirable for the sampling region to impartially contain the repetitive units of the pattern. As a result, even when the pattern is randomly placed on the inspection target, the differences between the repetitive patterns can entirely be incorporated in the noise signals.

Next, in Step S102, a preparatory inspection is performed. This is a process of performing the preparatory inspection with respect to the sampling region to evaluate noise. Specifically, the inspection target (e.g., a substrate) is irradiated with an energy beam (e.g., an electromagnetic wave) so that the energy beam reflected from the inspection target is obtained as an image signal and noise contained in the image signal is evaluated. In the preparatory inspection, it is unnecessary to set a threshold for counting the number of defects.

FIG. 2A shows signal data (image signal) obtained in Step S102. As shown in FIG. 2A, signal data 201 serving as image information is obtained by using a defect inspection apparatus and the obtained signal data 201 is converted to a digital signal (digital image signal) by A/D conversion. The digital signal contains therein a noise signal and an actual defect signal. The defect signal is defined herein as a signal indicating the presence of an abnormality (actual defect) such as the deformation of a pattern or the presence of a foreign material on the inspection target. The noise signal is a signal generated by the displacement of an inspection pattern occurred during the pattern comparison or color unevenness, though the noise signal does not indicate the deformation of the pattern or the presence of the foreign material on the inspection target. Accordingly, the noise signal is a signal not intended to be recognized as a defect in a defect inspection.

In the present embodiment, the area of the sampling region has been set small relative to the entire area of the region to be inspected in Step S101 so that actual defects are scarcely contained in the sampling region. Consequently, the signal data 201 obtained in Step S101 is composed only of the noise signal, as shown in FIG. 2A.

In the case where a repetitive pattern exists on the inspection target, the differences between the data signals 201 from a plurality of regions composing the repetitive pattern in the same inspection target are obtained. As a result, a signal resulting from the pattern itself is cancelled in principle so that high-accuracy data detection is enabled. Accordingly, it is assumed that differential image data is used for an inspection target having a repetitive pattern in data processing which will be described below. It is also assumed that either differential image data obtained by properly dividing a region to be inspected or unprocessed image data is used for an inspection target with no pattern in the data processing which will be described below.

Next, in Step S103, data transformation (frequency transformation) is performed. In the data transformation, frequency transformation is performed with respect to a digital signal obtained as a result of the preparatory inspection in Step S102. The frequency transformation is the transformation of data representing the relationship between an inspection position (inspection location) and a signal intensity as shown in FIG. 2A to data representing the relationship between the signal intensity and a signal frequency (the number of detected signals). FIG. 2B shows data obtained by performing the frequency transformation with respect to the signal data obtained in Step S102. In the data shown in FIG. 2B, the abscissa axis represents each of discrimination tones (256 tones) which are values obtained by discretizing the signal intensities and the ordinate axis represents the number of detected signals for the individual discrimination tones (a scale of 256 tones).

Since the noise signals are normally distributed in general, the present embodiment assumes that the noise signal data (sampling data 202) obtained in Step S103 is normally distributed. That is, when the signal intensity (which is the discrimination tone in the present embodiment) is assumed to be t, the number F(t) of detected signals is normally distributed, as shown in FIG. 2B. The number F(t) of detected signals is given by (Numerical Expression 1) shown below:
F(t)∝e^{-t}^{²} (Numerical Expression 1)

The number F(t) of detected signals is normally distributed centering around the mean value m of the noise signal intensities which satisfies t=(t−m)/a where a is a coefficient associated with the variation range, though it is not particularly described in (Numerical Expression 1).

Thus far, the preparatory inspection in Step S102 and the data transformation (frequency transformation) in Step S103 have been described as different processes. However, the processes of the preparatory inspection in Step S102 and the data transformation (frequency transformation) in Step S103 are preferably performed simultaneously. This is because, for the two processes to be performed individually, all the data should be stored temporarily so that a memory with an enormous capacity becomes necessary. If the data obtained in the preparatory inspection in Step S102 is simultaneously added up in counters provided for the individual discrimination tones on a one-by-one basis, the same number of memories as the discrimination tones are sufficient to temporarily store the data. This allows the data transformation (frequency transformation) in Step S103 to be performed easily and simultaneously with the preparatory inspection in Step S102.

Next, in Step S104, data transformation (denominator transformation) is performed. Specifically, since the denominator of the number of detected signals in the sampling region is different from that in the entire region to be inspected, the number of detected noise signals (sampling data 202) obtained from the sampling region is corrected to population data 203 from the entire region to be inspected by multiplying the number of the noise signals detected in the sampling region by (Entire Area of Region to be Inspected/Area of Sampling Region=1/Rs). For example, when the area of the sampling region is set to about 10% of the entire area of the region to be inspected, the population data 203 is obtained by multiplying the sampling data 202 by 10.

It is assumed that data processing which will be described below is performed with respect to the population data 203 from the entire region to be inspected. In FIGS. 2B to 2E, however, the sampling data 202 from the sampling region and the population data 203 from the entire region to be inspected are shown in combination.

In the data after the frequency transformation shown in FIG. 2B, the ordinate axis represents the number of detected signals and the abscissa axis represents the discrimination tone. However, the number of the population data sets 203 obtained in Step S104 becomes larger as the inspection unit (pixel size) becomes smaller.

Next, in Step S105, data transformation (cumulative transformation) is performed. Specifically, the number of noise signals each having an intensity not less than a given discrimination tone is counted for the population data 203 from the entire region to be inspected obtained in Step S104, whereby the population data 203 is transformed to data indicative of the relationship between the signal intensity (discrimination tone) and the cumulative number of detected signals. FIG. 2C shows the data obtained as a result of the cumulative transformation in Step S105. In FIG. 2B, the abscissa axis represents the discrimination tone (t) and the ordinate axis represents the cumulative number S(t) of detected signals obtained by integrating the number of the detected noise signals each having an intensity not less than the discrimination tone (t) with the discrimination tone (t). The cumulative number S(t) of detected signals is given by (Numerical Expression 2) shown below:

$$\begin{matrix}S ( t ) = \int F ( t ) ⅆ t \\ = erf c ( t ) \\ = \sqrt{π} ( 1 - F ( \sqrt{2} t ) )\end{matrix} \qquad ( Numerical Expression 2 )$$

where an integral interval is t=t˜∞.

Next, in Step S106, data transformation (logarithmic transformation) is performed in Step S106. Specifically, logarithmic transformation is performed with respect to the population data 203 from the entire inspected region obtained in Step S105. FIG. 2D shows the data obtained as a result of the logarithmic transformation in Step S106. The logarithmic transformation is defined herein as the transformation of the cumulative number S(t) of detected signals to a logarithmic value L(t). That is, when the total number of the population data sets 203 is assumed to be N, the logarithmic value L(t) is given by (Numerical Expression 3) shown below:
L(t)=log(S(t)/N) (Numerical Expression 3)

Next, in Step S107, data transformation (cube root transformation) is performed in Step S107. Specifically, cube root transformation is performed with respect to the population data 203 after the logarithmic transformation obtained in Step S106. FIG. 2E shows the data obtained as a result of the cube root transformation in Step S107. The cube root transformation is defined herein as the transformation of the logarithmic value L(t) of the cumulative number S(t) of detected signals to a cube root G(t). That is, the cube root G(t) is given by (Numerical Expression 4) shown below:

$$G ( t ) = \sqrt[3]{L ( t )} ∞ \text{-} t \qquad ( Numerical Expression 4 )$$

It is to be noted that the cube root G(t) defines a straight line proportional to −t in the interval of t in which data exists. In the interval of t not more than te at which the G(t) has a maximum value, G(t)=G(te) is constantly satisfied.

Next, in Step S108, data decomposition is performed. The present embodiment determines the threshold with high accuracy even when the noise signals are complicated by assuming that the noise signals are constituted by a combination of a plurality of normal distributions. However, when a majority of the noise signals result from background color unevenness such as when no pattern exists on the inspection target, data decomposition need not be performed. Even when a pattern exists on the inspection target or when the pattern existing on the inspection target is an extremely small repetitive pattern which is not larger in size than the inspection pixel size and therefore the pattern can be ignored, data decomposition need not be performed, either.

A description will be given first to the flow of data processing in Step S109 and thereafter when data decomposition in Step S108 need not be performed.

In this case, threshold setting is performed in Step S109. Specifically, a cube root G(t) which satisfies S(t)=1 is determined first to determine a cross point t0 for the G(t), as shown in FIG. 2E. That is, the cross point to which satisfies G(t0)=(log(1/N))^{1/3} is determined by using a linear approximation expression for the G(t).

Here, S(t)=1 indicates that the cumulative number of detected signals is 1 and t0 indicates the maximum intensity of each of the noise signals. Therefore, as shown in FIG. 2F, the present embodiment which represents the signal intensity by using the discrimination tone which is a digital value sets the discrimination tone higher by one tone than the discrimination tone to which to belongs to a defect detection threshold tₜₕ. In other words, the maximum discrimination tone at which the cumulative number S(t) of detected signals is less than 1 is set to the defect detection threshold tₜₕ. That is, if to is a number having decimal places, Tₜₕ becomes an integer obtained by rounding up the decimal places of to.

To calculate to with high accuracy, it is effective to use data in the vicinity of to as data for obtaining the linear approximation expression for the G(t). In the case of performing linear approximation using the data in the vicinity of to, specifically data on the G(t) with which t is t0-1, t0-2, . . . and t0-n, n with which S(t0-n) x Sampling Ratio Rs is 100 or more is used. Specifically, when Rs is 10%, n with which S(t0-n) is 1000 or more is used and, when Rs is 1%, n with which S(t0-n) is 10000 or more is used. At this time, if the number of data sets used in the linear approximation is 4 or more, sufficient approximation accuracy is obtainable. Although the maximum intensity t0 of each of the noise signals as digital signals described above is calculated as an extrapolation value by the linear approximation, the consistency between actual data and the approximation line is high for the maximum intensity t0 since the linear approximation has been performed by using the data in the vicinity of the maximum intensity t0. This allows high-accuracy calculation of the maximum intensity t0 of the noise signal.

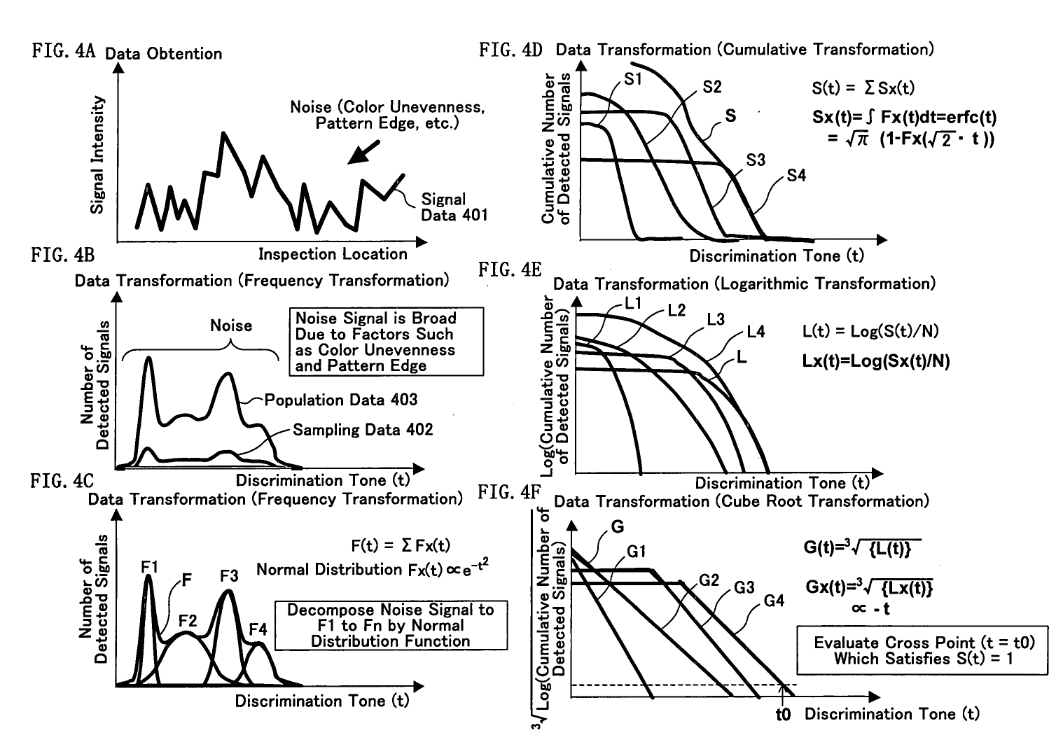

A description will be given herein below to the content of processing leading to threshold setting in Step S109 when data decomposition in Step S108 is necessary with reference to FIGS. 4A to 4F. In FIGS. 4A to 4F, data shown in FIGS. 4B to 4F corresponding to original data prior to the data decomposition performed after the data transformation (cube root transformation) shown in FIG. 4F is also shown with data obtained as a result of the data decomposition for the purpose of illustrating the data decomposition in Step S108. Noise signal data decomposed in the data decomposition in Step S108 is the cube root G(t) function shown in (Numerical Expression 4). In Step S108, the proportionality of G(t) to −t is used.

First, when the pattern (underlying pattern) on the inspection target is complicated, signal data (image signal) 401 obtained in Step S102, i.e., the noise signal has signal variations resulting from color unevenness, a pattern edge, and the like, as shown in FIG. 4A. When the data transformation (frequency transformation) in Step S103 and the data transformation (denominator transformation) in Step S104 are performed with respect to the noise signal, sampling data 402 and population data 403 each shown in FIG. 4B are obtained. As shown in FIG. 4C, the data shown in FIG. 4B is generated by a plurality of noise signals overlapping each other. FIG. 4C shows the case where four noise components (F1, F2, F3, and F4) are overlapping each other. In FIG. 4C, each of the noise signal components shows a normally distributed configuration but the respective numbers of the noise signal components (the numbers of detected signals), the variation ranges thereof, and the mean values thereof are different from each other. FIG. 4C also shows a frequency distribution function Fx(t) for the signal intensity (which is the discrimination tone in the present embodiment) of each of the noise signal components, where x is the number of the noise components. The number F(t) of actually detected signals is given as the sum of the individual noise signal components by (Numerical Expression 5) shown below:
F(t)=ΣFx(t) (Numerical Expression 5)
and the Fx(t) is given by (Numerical Expression 6) shown below:
Fx(t)=∝e^{-t}^{²} (Numerical Expression 6)

Next, the data shown in FIG. 4C is transformed to the data shown in FIG. 4D as a result of the data transformation (cumulative transformation) in Step S105. The cumulative number S(t) of the actually detected noise signals is given as the sum of the respective cumulative numbers Sx(t) of the individual noise signal components for the discrimination tone (t) thereof by (Numerical Expression 7) shown below:
S(t)=ΣSx(t) (Numerical Expression 7)
and the Sx(t) is given by (Numerical Expression 8) shown below:
Sx(t)=∫Fx(t)dt (Numerical Expression 8)
where an integral interval is t=t˜∞.

Next, the data shown in FIG. 4D is transformed to the data shown in FIG. 4E as a result of the data transformation (logarithmic transformation) in Step S106. The logarithmically transformed cumulative number L(t) of actually detected noise signals and the logarithmically transformed cumulative number Lx(t) of each of the noise signal components are given by (Numerical Expression 9) and (Numerical Expression 10) shown below, respectively:
L(t)=log(S(t)/N) (Numerical Expression 9)
Lx(t)=log(Sx(t)/N) (Numerical Expression 10)
where N is the total number of population data sets.

Next, the data shown in FIG. 4E is transformed to data shown in FIG. 4F as a result of the data transformation (cube root transformation) in Step S107. The logarithmically transformed cube-root cumulative number G(t) of actually detected signals and the logarithmically transformed cube-root cumulative number Gx(t) of each of the noise signal components are given by (Numerical Expression 11) and (Numerical Expression 12) shown below, respectively:

$$\begin{matrix}G ( t ) = \sqrt[3]{L ( t )} ∞ \text{-} t & ( Numerical Expression 11 ) \\ Gx ( t ) = \sqrt[3]{Lx ( t )} ∞ \text{-} t & ( Numerical Expression 12 )\end{matrix}$$

where each of the cube roots G (t) and Gx(t) defines a straight line proportional to −t in the interval of t in which data exists.

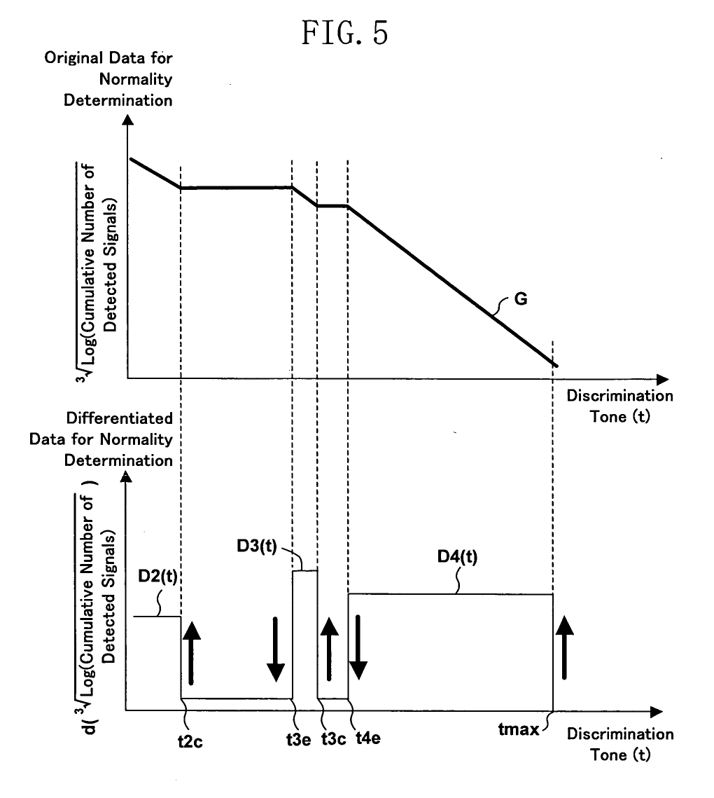

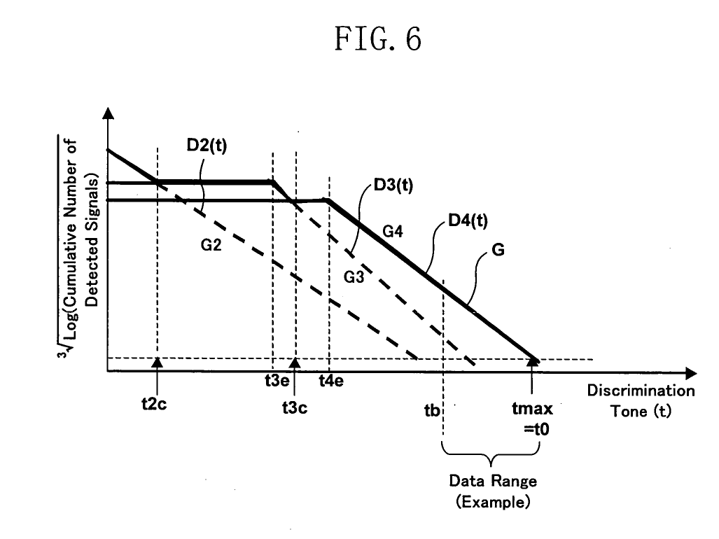

Next, in Step S108, data decomposition is performed as shown in FIGS. 5 and 6. Then, threshold setting is performed in Step S109.

First, as shown in FIGS. 4F and 5, G(t) which satisfies S(t)=1 is determined to obtain the cross point t0 for the cube root G(t). Specifically, as shown in FIG. 5, the cube root G(t) is differentiated in the minus direction of t to obtain D(t)=dG(t)/dt.

Next, the discrimination tone t which orients the D(t) in the plus direction (hereinafter referred to as a data start tone txc) is detected in the minus direction of t. At this time, the maximum value tmax of the data start tone txc shows the maximum intensity of the noise signal (i.e., the cross point t0 shown in FIG. 4F). As for the txc which is less than the maximum data start tone tmax, it shows the presence of another noise signal component.

Next, the discrimination tone t which orients the D(t) in the minus direction (hereinafter referred to as a data end tone txe) is detected in the minus direction of t. The data end tone txe shows the discrimination tone with which a given noise signal component no more exists.

Next, the value of D(t) at which the D(t) becomes constant (i.e., the gradient Dx(t) of G(t))) is detected in the minus direction of t.

Next, as shown in FIG. 6, G(t) is decomposed to Gx(t) by using the maximum data start tone tmax, the data end tone txe, the data start tone txc, and the gradient Dx(t) of G(t) obtained as a result of the process shown in FIG. 5. In FIG. 6, each of the broken lines indicates Gx(t) after decomposition.

Next, a data range for determining the threshold is determined by performing the linear approximation for G(t). One of requirements for determining the data range is that the data range is not less than the discrimination tone (which is the data end tone t4e in FIG. 6) with which the gradient starts to decrease when the graph of G(t) is viewed from the side on which the discrimination tone t is larger. Another of the requirements for determining the data range is that n has a value (which is the tone tb in FIG. 6) with which S(t0-n) x Sampling Ratio Rs is 100 or more. The foregoing is the content of the process decomposition in Step S108.

Next, in Step S109, threshold setting is performed. Specifically, when data on another Gx(t) exists in the data range described above, data for linear approximation (which is data on G4 in FIG. 6) is obtained by subtracting an increment in data resulting from the Gx(t) therefrom. Subsequently, the cross point t0 which satisfies S(t)=1 is determined by using data (data for the linear approximation) on Gx(t) passing through the tmax. Finally, the discrimination tone higher by one tone than the discrimination tone to which t0 belongs is set to the defect detection threshold tₜₕ. In other words, the maximum discrimination tone with which the cumulative number S(t) of detected signals is less than 1 is set to the defect detection threshold tₜₕ.

Next, in Step S110, the various data items (signal distribution data) obtained in Steps S101 to S109 are outputted to a database (defect database).

Thus, according to the first embodiment, even when the defect density in the substrate to be inspected is particularly low or when the ratio between the defect signal and the noise signal is particularly low, the threshold for defect detection can be set with high accuracy in a short time based on the maximum intensity of the noise signal from the substrate to be inspected by evaluating the noise signal including color unevenness in the substrate to be inspected and the like. In other words, the defect detection threshold can be set uniquely and automatically. In particular, the evaluation of the noise signals obtained from the inspection of the sampling region set impartially to the entire region to be inspected allows high-accuracy and shorter-time setting of the defect detection threshold. As a result, it becomes possible to minimize the possibilities of the erroneous detection of a defect and the missing of a detect and reduce inspection variations.

Since the first embodiment has determined the defect detection threshold in consideration of the noise signals from the inspection target, it becomes possible to prevent the erroneous detection of a defect or the missing of a defect which is caused by variations in noise signal (background noise) resulting from color unevenness in the substrate to be inspected and the like.

In addition, since the first embodiment allows high-accuracy setting of a proper threshold in accordance with a substrate to be inspected even when the cumulative number of defects detected therefrom is small and therefore it is difficult to set the threshold by using actual defects, it becomes possible to perform defect inspection in which the erroneous detection of a defect and the missing of a defect are minimized. Moreover, the time required for threshold setting can be reduced significantly and the threshold setting can be automated by using a computer and software.

In the first embodiment, the ratio (Sampling Ratio Rs) of the area of the sampling region for determining the defect detection threshold to the area of the entire region to be inspected has been set to the range not less than 1% and not more than 10%. However, when the defect density in an inspection target is low and the time required to inspect the sampling region is short, i.e., when the inspection is substantially operable, the sampling ratio Rs may also exceed 10%.

In the first embodiment, the type of the energy beam used for the preparatory inspection in Step S102 is not particularly limited. For example, an electromagnetic wave such as a light beam, an electron beam, a radioactive beam, or the like can be used.

The first embodiment has described that the process of the preparatory inspection in Step S102 and the process of the data transformation (frequency transformation) in Step S103 are preferably performed simultaneously, i.e., that, if data obtained in the preparatory inspection is simultaneously added up in the counters provided for the individual discrimination tones on a one-by-one basis, only the same number of memories as the discrimination tones may be prepared appropriately for the temporary storage of data and the data transformation (frequency transformation) in Step S103 can be performed easily and simultaneously with the preparatory inspection in Step S102. Instead, however, it is also possible to skip the process of the data transformation (frequency transformation) in Step S103 and obtain the data shown in FIG. 2C through the preparatory inspection in Step S102 and the data transformation (cumulative transformation) in Step S105. Specifically, it is appropriate to obtain data in the preparatory inspection, while determining in real time the intensities of signals detected successively during the inspection, and add to, when each of the intensities is not less than a given value (discrimination tone), the number of detected signals for the discrimination tone. The arrangement allows the omission of the data transformation (frequency transformation) in Step S103 and thereby allows higher-speed processing to be performed. In this case, although the signal processing performed while obtaining data is performed by using memories and arithmetic operation units, dedicated memories and dedicated arithmetic operation units are preferably used for the signal processing to increase the speed of the processing in consideration of a load on each of the inspection apparatus and application software during the inspection.

### Embodiment 2

Referring to the drawings, a defect inspection method according to a second embodiment of the present invention will be described with reference to the drawings.

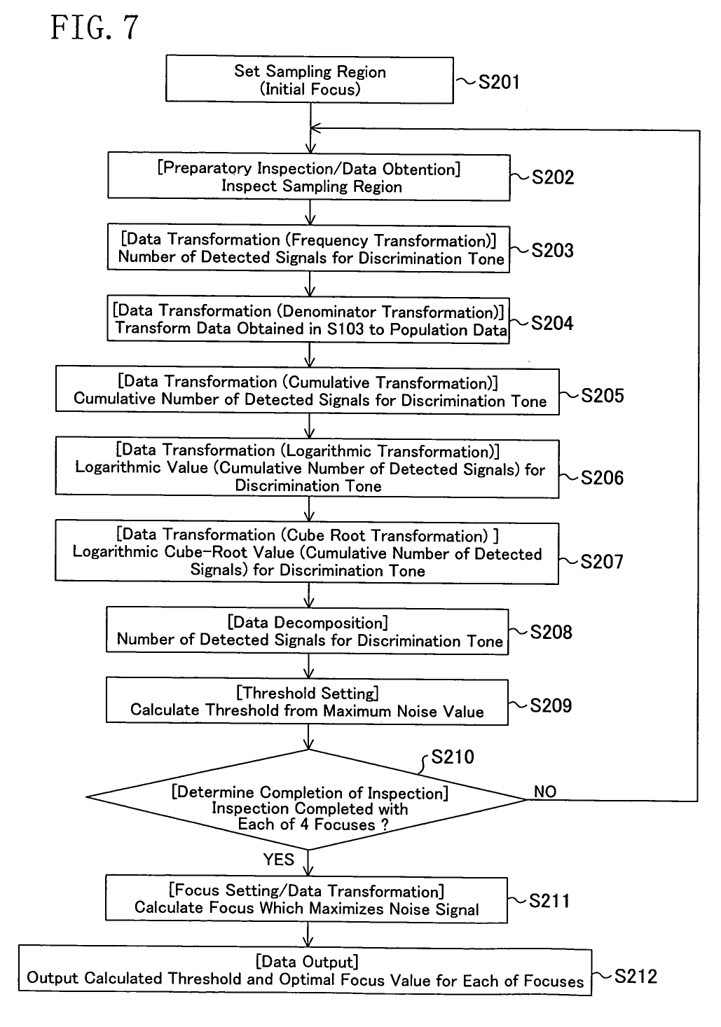

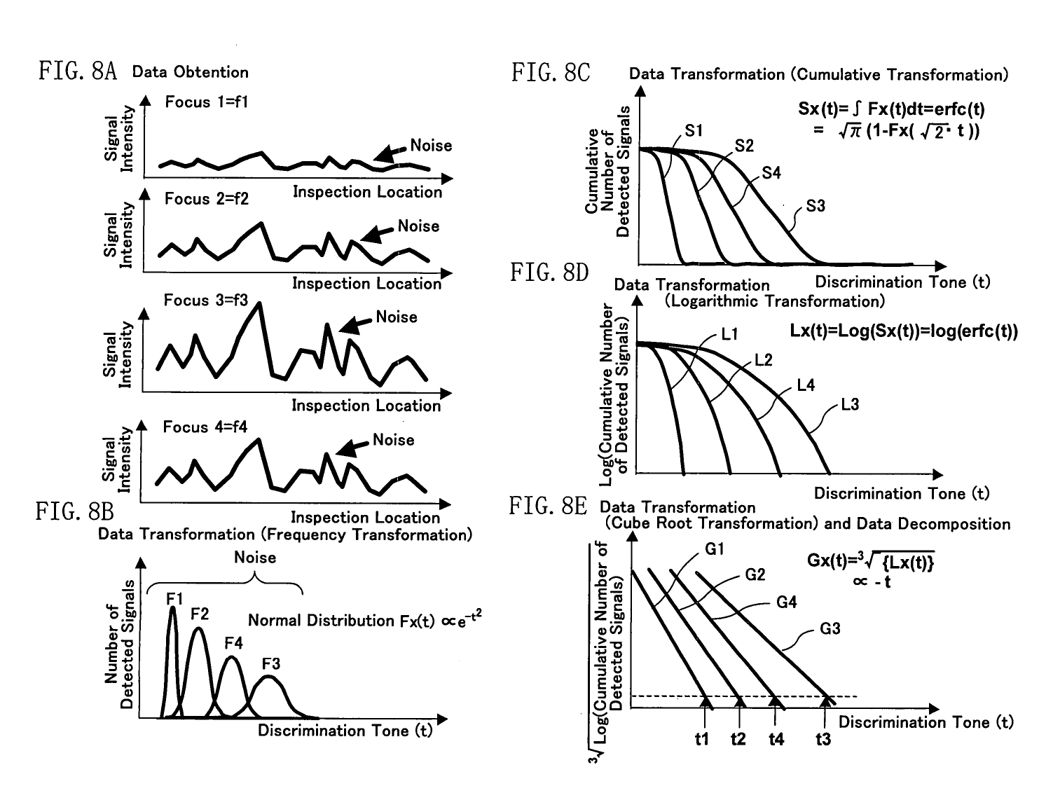

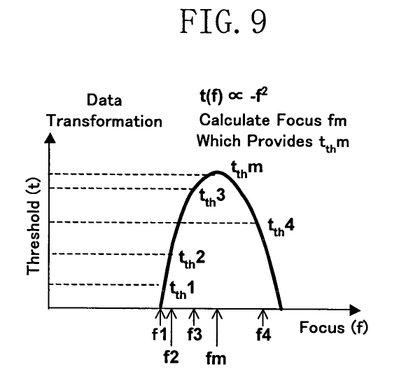

FIG. 7 shows a process flow of the defect inspection method according to the second embodiment, specifically a method for determining an inspection focus by noise evaluation according to the present invention. FIGS. 8A to 8E and FIG. 9 are views for illustrating the individual steps of the process flow (particularly a signal transformation method in accordance with a noise evaluation algorithm) shown in FIG. 7. Specifically, FIG. 8A corresponds to Step S202 of FIG. 7, FIG. 8B corresponds to Steps S203 and S204 of FIG. 7, FIG. 8C corresponds to Step S205 of FIG. 7, FIG. 8D corresponds to Step S206 of FIG. 7, FIG. 8E corresponds to Steps S207 and S208 of FIG. 7, and FIG. 9 corresponds to Step S211 of FIG. 7. In the present embodiment, an image signal is retrieved from a defect inspection apparatus, noise evaluation is performed with respect to the retrieved signal, and a threshold for the inspection focus is determined based on the result of noise evaluation in the process steps shown in FIGS. 8A to 8E and FIG. 9.

In the setting of the inspection focus according to the present embodiment, the focus is varied in, e.g., four levels and, by using the defect detection threshold obtained with the focus in each level, a focus value which allows the threshold to be maximized is determined.

Specifically, first in Step S201, the setting of a sampling region is performed and the initial setting of the focus is performed. Subsequently, the focus is varied in four levels and the process from a preparatory inspection in Step S202 to threshold setting in Step. S209 is performed for the focus in each level. As for the content of processing in Steps S201 through S209 (see FIGS. 8A to 8E), it is basically the same as the content of the processing in Steps S101 to S109 in the first embodiment so that the detailed description thereof will be omitted. For clarity of illustration, a plurality of noise signal components composing a noise signal obtained with the focus in each level are not shown for data decomposition illustrated in FIG. 8E but only a noise signal component having a maximum signal intensity after the data decomposition is shown.

Next, it is determined in Step S210 whether or not the inspection using the focus in each of the four levels has been completed. When the inspection has been completed, the whole process flow advances to focus setting in Step S211. In the threshold setting in Step S209, it is assumed that a defect detection threshold obtained for each of the inspection focuses (x=1 to 4) is tₜₕ (fx).

Next, in Step S211, the focus setting is performed. In the present embodiment, as shown in FIG. 9, the relationship between the threshold t and the focus f is approximated with the upwardly convex square curve of f, which is given by (Numerical Expression 13) shown below:
tₜₕ(f)∝−f² (Numerical Expression 13)
Then, a focus value fm which maximizes t(f) is determined by using the least squares method. The focus value fm obtained thereby becomes an optimal focus. The reason for this is as follows. In the case of performing an inspection by using the focus value fm, the defect detection threshold becomes maximal. It follows therefore that the amplitude, i.e., intensity of the noise signal is large in that case.

Next, in Step S212, the defect detection threshold tₜₕ(fx) and the optimal focus value fm obtained for each of the inspection focuses fx(x=1 to 4) is outputted in Step S212.

As described above, the second embodiment achieves the following effect in addition to the same effect as achieved by the first embodiment. That is, a proper focus in accordance with the substrate to be inspected can be set uniquely and automatically with higher accuracy than achieved by the prior art technology which has performed focus setting by using the image contrast of the substrate to be inspected. In particular, the evaluation of the noise signals obtained from the inspection of the sampling region set impartially to the entire region to be inspected allows high-accuracy setting of a focus considering the noise signals from the inspection target. As a result, a defect inspection which is low in the possibilities of the erroneous detection of a defect and the missing of a defect and features reduced inspection variations can be performed.

In addition, the second embodiment allows a significant reduction in the time required for focus setting and allows focus setting to be automated by using a computer and software, as will be described later.

Although the second embodiment has derived the optimal focus by varying the focus in four levels, it is not limited thereto. The optimal focus may also be derived by varying the focus in an arbitrary number of levels not less than 3 in accordance with an inspection time, the state of an inspection target, and the like.

In the second embodiment, the type of an energy beam used in the preparatory inspection in Step S202 is not particularly limited. For example, it is also possible to use, e.g., an electromagnetic wave such as a light beam, an electron beam, or a radioactive beam. Although the present embodiment has performed focus setting on the presumption that the light beam is used as the energy beam, parameters other than the focus, such as a wavelength, may also be set similarly. For a selected parameter, a value which maximizes sensitivity can be obtained. In the case of using an electron beam as an energy beam, the setting of parameters such as a focus provided by an electronic lens, an acceleration energy, and an energization current can also be performed similarly.

To set a focus with high accuracy in a short period of time in the second embodiment, the ratio (Sampling Ratio Rs) of the area of the sampling region to the area of the entire region to be inspected is preferably set to the range not less than 1% and not more than 10%. However, when the defect density in an inspection target is low and the time required to inspect the sampling region is short, i.e., when the inspection is substantially operable, the sampling ratio Rs may also exceed 10%.

In the second embodiment, the process of the preparatory inspection in Step S202 and the process of the data transformation (frequency transformation) in Step S203 are preferably performed simultaneously. Specifically, if data obtained in the preparatory inspection is simultaneously added up in the counters provided for the individual discrimination tones on a one-by-one basis, only the same number of memories as the discrimination tones may be prepared appropriately for the temporary storage of data and the data transformation (frequency transformation) in Step S203 can be performed easily and simultaneously with the preparatory inspection in Step S202. Instead, however, it is also possible to skip the process of the data transformation (frequency transformation) in Step S203 and obtain the data shown in FIG. 8C through the preparatory inspection in Step 5202 and the data transformation (cumulative transformation) in Step S205. Specifically, it is appropriate to obtain data in the preparatory inspection, while determining in real time the intensities of signals detected successively during the inspection, and add to, when each of the intensities is not less than a given value (discrimination tone), the number of detected signals for the discrimination tone. The arrangement allows the omission of the data transformation (frequency transformation) in Step S203 and thereby allows higher-speed processing to be performed. In this case, although the signal processing performed while obtaining data is performed by using memories and arithmetic operation units, dedicated memories and dedicated arithmetic operation units are preferably used for the signal processing to increase the speed of the processing in consideration of a load on each of the inspection apparatus and application software during the inspection.

### Embodiment 3

Referring to the drawings, a defect inspection method according to a third embodiment of the present invention will be described with reference to the drawings.

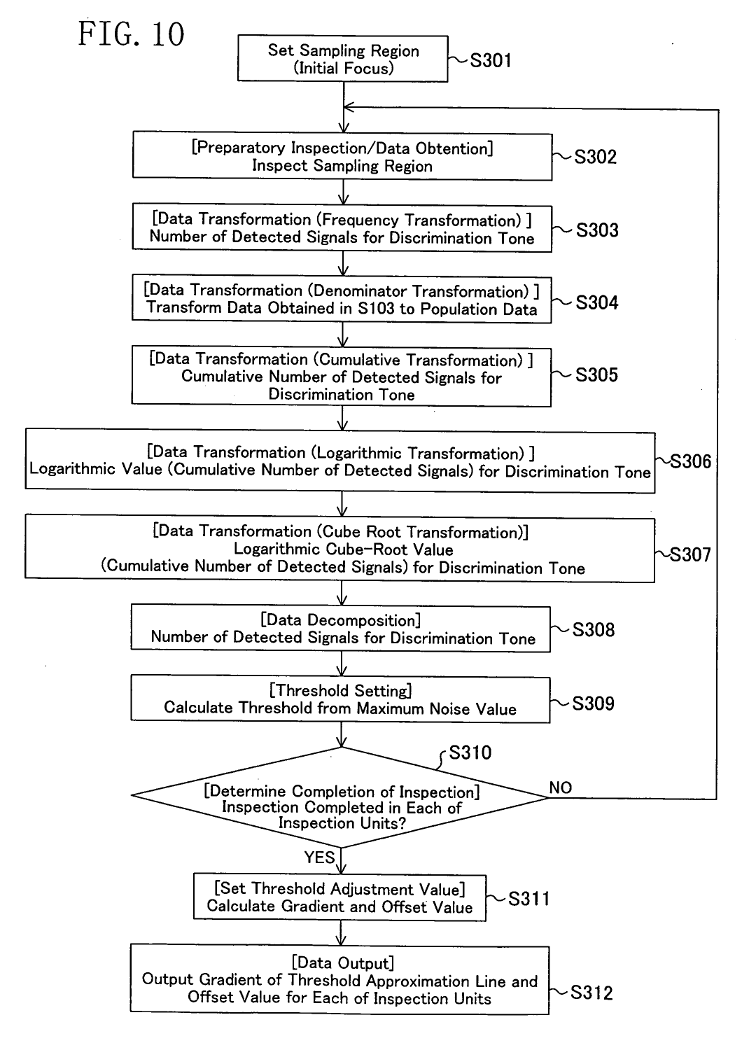

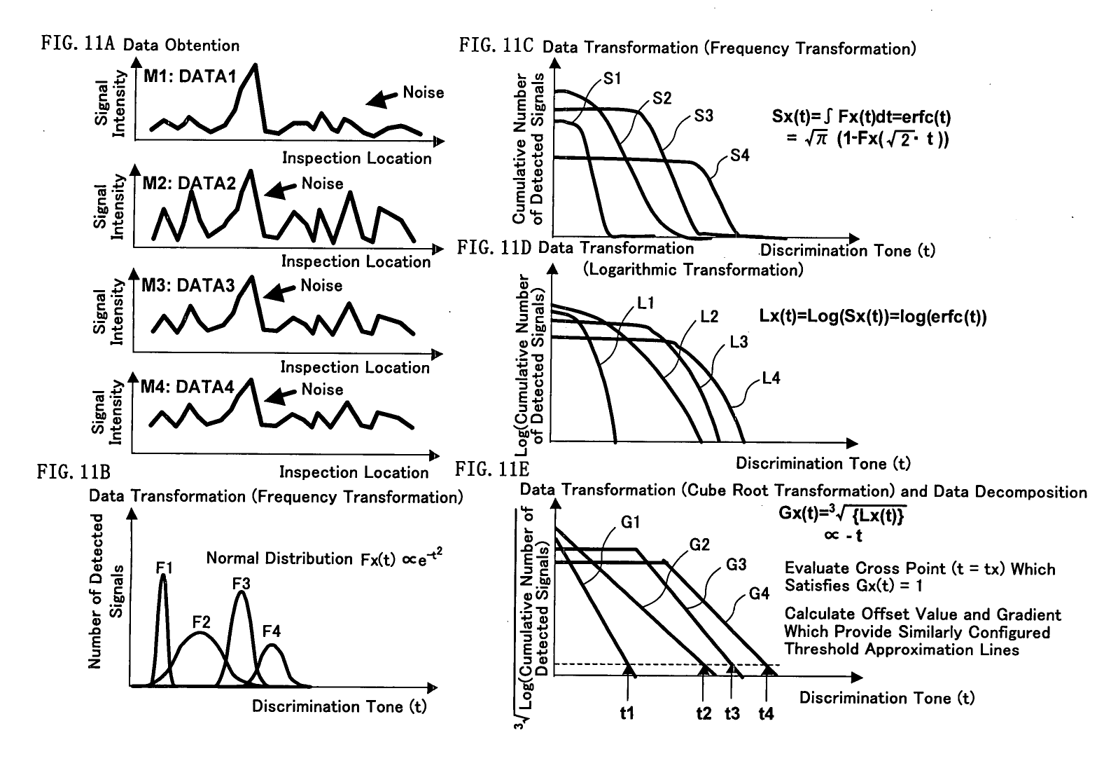

FIG. 10 shows a process flow of the defect inspection method according to the third embodiment, specifically a method for adjusting inspection characteristics such that each of a plurality of inspection units (detection systems) provided in an inspection apparatus has the same inspection sensitivity based on noise evaluation according to the present invention. FIGS. 101A to 11E are views for illustrating the individual steps of the process flow (particularly a signal transformation method in accordance with a noise evaluation algorithm) shown in FIG. 10. Specifically, FIG. 11A corresponds to Step S302 of FIG. 10, FIG. 11B corresponds to Steps S303 and S304 of FIG. 10, FIG. 11C corresponds to Step S305 of FIG. 10, FIG. 11D corresponds to Step S306 of FIG. 10, and FIG. 11E corresponds to Steps S307 and S308 of FIG. 10. In the present embodiment, an image signal is retrieved from a defect inspection apparatus, noise evaluation is performed with respect to the retrieved signal, and a threshold offset and a coefficient for each of the inspection units, which will be described later, are determined based on the threshold obtained from the result thereof in the processing shown in FIGS. 8A to 8E.

First in Step S301, the setting of a sampling region is performed. Then, the process from a preparatory inspection in Step S302 to threshold setting in Step S309 is performed for each of the inspection units. As for the content of processing in Steps S301 to S309 (see FIGS. 11A to 11E), it is basically the same as the content of the processing in Steps S101 to S109 in the first embodiment so that the detailed description thereof will be omitted. For clarity of illustration, a plurality of noise signal components composing a noise signal obtained by each of the inspection units are not shown for data decomposition illustrated in FIG. 11E but only a noise signal component having a maximum signal intensity after the data decomposition is shown.

Next, it is determined in Step S310 whether or not the inspection in each of the inspection units has been completed. When the inspection has been completed, the whole process flow advances to the setting of a threshold adjustment value in Step S311. In the threshold setting in Step S309, it is assumed that a defect detection threshold and a logarithmically transformed cube-root cumulative number of noise signals obtained for each of the inspection units (x=1 to 4 is satisfied in the present embodiment) are tₜₕx and Gx(t), respectively.

Next, in Step S311, the setting of the threshold adjustment value is performed. Specifically, each Gx(t) is first differentiated with respect to the signal intensity (which is the discrimination tone in the present embodiment) t to provide the gradient Dx=dGx(t)/dt of each Gx(t). Then, an offset value t0x for the threshold tₜₕx and a coefficient αx for the gradient Dx are obtained for each of the inspection units x by using the respective medians (tₜₕx) and (Dx) of tₜₕx and Dx, (Numerical Expression 14), and (Numerical Expression 15) shown below, whereby the inspection characteristic of each of the inspection units x is adjusted:
Median(tₜₕx)=tₜₕx+t0x (Numerical Expression 14)
Median(Dx)=αxDx (Numerical Expression 15)
Specifically, the offset value t0x is added to each of the thresholds tₜₕx to provide the same median (tₜₕx), as shown by (Numerical Expression 14). On the other hand, each of the gradients Dx is multiplied by the coefficient αx to provide the same median (Dx).

Next, in Step S312, the gradient (gradient of the threshold approximation line Gx(t)) Dx and the offset value t0x obtained for each of the inspection units x are outputted.

As described above, the third embodiment achieves the following effect in addition to the same effect as achieved by the first embodiment. That is, even when the defect inspection apparatus having the plurality of detection systems is used, threshold correction can be performed such that each of the detection systems has the same defect detection threshold. Accordingly, the defect detection threshold of each of the detection systems can be held constant and proper with high accuracy. In other words, the defect detection thresholds can be adjusted uniquely and automatically. As a result, a defect inspection which is low in the possibilities of the erroneous detection of a defect and the missing of a defect and features reduced inspection variations can be performed.

Since the third embodiment has performed fitting such that the threshold calculated based on the maximum intensity of the noise signal obtained by each of the inspection units (detection systems) is constant, threshold correction which reduces the differences between the respective thresholds of the individual inspection systems can be performed.

In addition, the third embodiment also allows the specification of an abnormal inspection system based on variations in the respective thresholds tₜₕx and gradients Dx of the individual inspection systems. As a method for the specification, a test using, e.g., analysis of variance with respect to statistic data may also be used.

It will easily be understood that the number of the detection systems is not limited in the third embodiment.

In the third embodiment, the type of an energy beam used in the preparatory inspection in Step S302 is not particularly limited. For example, it is also possible to use, e.g., an electromagnetic wave such as a light beam, an electron beam, or a radioactive beam.

To perform threshold correction with high accuracy in a short period of time in the third embodiment, the ratio (Sampling Ratio Rs) of the area of the sampling region to the area of the entire region to be inspected is preferably set to the range not less than 1% and not more than 10%. However, when the defect density in an inspection target is low and the time required to inspect the sampling region is short, i.e., when the inspection is substantially operable, the sampling ratio Rs may also exceed 10%.

In the third embodiment, the process of the preparatory inspection in Step S302 and the process of the data transformation (frequency transformation) in Step S303 are preferably performed simultaneously. Specifically, if data obtained in the preparatory inspection is simultaneously added up in the counters provided for the individual discrimination tones on a one-by-one basis, only the same number of memories as the discrimination tones may be prepared appropriately for the temporary storage of data and the data transformation (frequency transformation) in Step S303 can be performed easily and simultaneously with the preparatory inspection in Step S302. Instead, however, it is also possible to skip the process of the data transformation (frequency transformation) in Step S303 and obtain the data shown in FIG. 11C through the preparatory inspection in Step S302 and the data transformation (cumulative transformation) in Step S305. Specifically, it is appropriate to obtain data in the preparatory inspection, while determining in real time the intensities of signals detected successively during the inspection, and add to, when each of the intensities is not less than a given value (discrimination tone), the number of detected signals for the discrimination tone. The arrangement allows the omission of the data transformation (frequency transformation) in Step S303 and thereby allows higher-speed processing to be performed. In this case, although the signal processing performed while obtaining data is performed by using memories and arithmetic operation units, dedicated memories and dedicated arithmetic operation units are preferably used for the signal processing to increase the speed of the processing in consideration of a load on each of the inspection apparatus and application software during the inspection.

### Embodiment 4

Referring to the drawings, a defect inspection method according to a fourth embodiment of the present invention will be described with reference to the drawings.

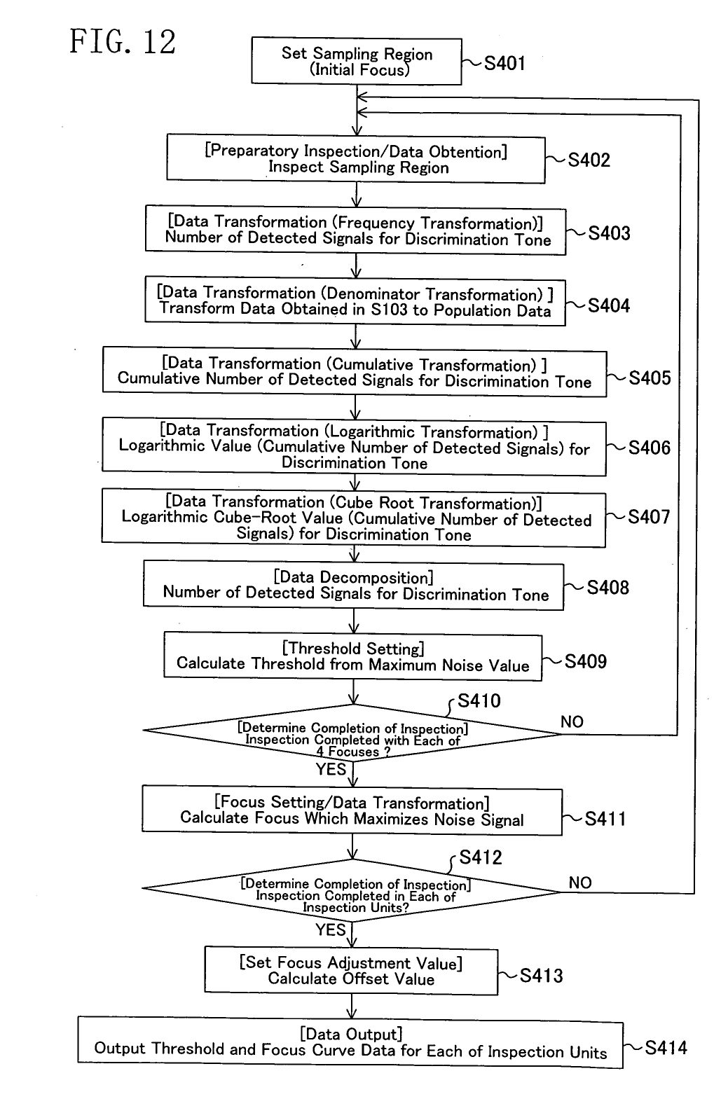

FIG. 12 shows a process flow of the defect inspection method according to the fourth embodiment, specifically a method for adjusting inspection characteristics such that each of a plurality of inspection units (detection systems) provided in an inspection apparatus has the same focus by noise evaluation according to the present invention.

In the present embodiment, the focus is varied in, e.g., four levels for each of the inspection units and a focus value which allows the threshold to be maximized is obtained by using the defect detection threshold obtained with the focus in each level in the same manner as in the second embodiment shown in FIGS. 7, 8A to 8E, and 9. Then, an offset value is added to the focus value such that each of the inspection units has the same focus value.

Specifically, first in Step S401, the setting of a sampling region is performed and the initial setting of the focus is performed. Subsequently, the focus is varied in four levels in each of the inspection units and the process from a preparatory inspection in Step S402 to threshold setting in Step S409 is performed. As for the content of processing in Steps S401 through S409, it is basically the same as the content of the processing in Steps S101 to S109 in the first embodiment or the content of the processing in Steps S201 to S209 in the second embodiment so that the detailed description thereof will be omitted. For clarity of illustration, a plurality of noise signal components composing a noise signal obtained by each of the inspection units are not shown for data decomposition in Step S408 but only a noise signal component having a maximum signal intensity after the data decomposition is shown.

Next, it is determined in Step S410 whether or not the inspection using the focus in each of the four levels has been completed in a given one of the inspection units. When the inspection has been completed, the whole process flow advances to focus setting in Step S411. As for the content of processing in Step S411, it is basically the same as the content of the processing in Step S211 in the second embodiment so that the detailed description thereof will be omitted.

Next, it is determined in Step S412 whether or not the inspection in the each of the inspection units has been completed. When the inspection has been completed, the whole process flow advances to the setting of a focus adjustment value in Step S413. It is assumed herein that an optimal focus value obtained for each of the inspection units (x=1 to 4 is satisfied in the present embodiment) in the focus setting in Step S411 is fmx.

Next, in Step S413, the setting of the focus adjustment value is performed. Specifically, an offset value f0x for the optimal focus value fmx is obtained for each of the inspection units x by using the median (fmx) of the respective optimal focus values fmx of the individual inspection units x and (Numerical Expression 16) shown below and the inspection characteristics of each of the inspection units x are adjusted.
Median(fmx)=fmx+f0x (Numerical Expression 16)
Specifically, the offset value f0x is added to each of the optimal focus values fmx to provide the same median (fmx), as shown by (Numerical Expression 16).

Next, in Step S414, the defect detection threshold tₜₕx and the optimal focus value fmx (focus curve data) obtained for each of the inspection units x (x=1 to 4) are outputted.

As described above, the fourth embodiment achieves the following effect in addition to the same effect as achieved by the first embodiment. That is, even when the defect inspection apparatus having the plurality of detection systems is used, focus correction can be performed such that each of the detection systems has the same inspection focus value. Accordingly, the inspection focus value of each of the detection systems can be held constant and proper with high accuracy. In other words, the inspection focus values can be adjusted uniquely and automatically. As a result, a defect inspection which is low in the possibilities of the erroneous detection of a defect and the missing of a defect and features reduced inspection variations can be performed.

Since the fourth embodiment has performed fitting such that the optimal focus value calculated based on the maximum intensity of the noise signal obtained by each of the inspection units (detection systems) is constant, focus correction which reduces the differences between the respective focuses of the individual inspection systems can be performed.

In addition, the fourth embodiment also allows the specification of an abnormal inspection system based on variations in the respective optimal focus values fmx of the individual inspection systems. As a method for the specification, a test using, e.g., analysis of variance with respect to statistic data may also be used.

It will easily be understood that the number of the detection systems is not limited in the fourth embodiment.

Although the fourth embodiment has derived the optimal focus by varying the focus in four levels, it is not limited thereto. The optimal focus may also be derived by varying the focus in an arbitrary number of levels not less than 3 in accordance with an inspection time, the state of an inspection target, and the like.

In the fourth embodiment, the type of an energy beam used in the preparatory inspection in Step S402 is not particularly limited. For example, it is also possible to use, e.g., an electromagnetic wave such as a light beam, an electron beam, or a radioactive beam. Although the present embodiment has performed focus setting on the presumption that the light beam is used as the energy beam, parameters other than the focus, such as a wavelength, may also be performed similarly. For a selected parameter, a value which maximizes sensitivity can be obtained. In the case of using an electron beam as an energy beam, the setting of parameters such as a focus provided by an electronic lens, an acceleration energy, and an energization current can also be performed similarly.

To set a focus with high accuracy in a short period of time in the fourth embodiment, the ratio (Sampling Ratio Rs) of the area of the sampling region to the area of the entire region to be inspected is preferably set to the range not less than 1% and not more than 10%. However, when the defect density in an inspection target is low and the time required to inspect the sampling region is short, i.e., when the inspection is substantially operable, the sampling ratio Rs may also exceed 10%.

In the fourth embodiment, the process of the preparatory inspection in Step S402 and the process of the data transformation (frequency transformation) in Step S403 are preferably performed simultaneously. Specifically, if data obtained in the preparatory inspection is simultaneously added up in the counters provided for the individual discrimination tones on a one-by-one basis, only the same number of memories as the discrimination tones may be prepared appropriately for the temporary storage of data and the data transformation (frequency transformation) in Step S403 can be performed easily and simultaneously with the preparatory inspection in Step S402. Instead, however, it is also possible to skip the process of the data transformation (frequency transformation) in Step S403 and obtain the cumulative number of detected signals through the preparatory inspection in Step S402 and the data transformation (cumulative transformation) in Step S405. Specifically, it is appropriate to obtain data in the preparatory inspection, while determining in real time the intensities of signals detected successively during the inspection, and add to, when each of the intensities is not less than a given value (discrimination tone), the number of detected signals for the discrimination tone. The arrangement allows the omission of the data transformation (frequency transformation) in Step S403 and thereby allows higher-speed processing to be performed. In this case, although signal processing performed while obtaining data is performed by using memories and arithmetic operation units, dedicated memories and dedicated arithmetic operation units are preferably used for the signal processing to increase the speed of the processing in consideration of a load on each of the inspection apparatus and application software during the inspection.

### Embodiment 5

Referring to the drawings, a defect inspection system, a defect inspection method, a S/N ratio evaluation method, and an inspection operation according to a fifth embodiment of the present invention, in each of which a noise evaluation algorithm according to the present invention has been incorporated, will be described with reference to the drawings.

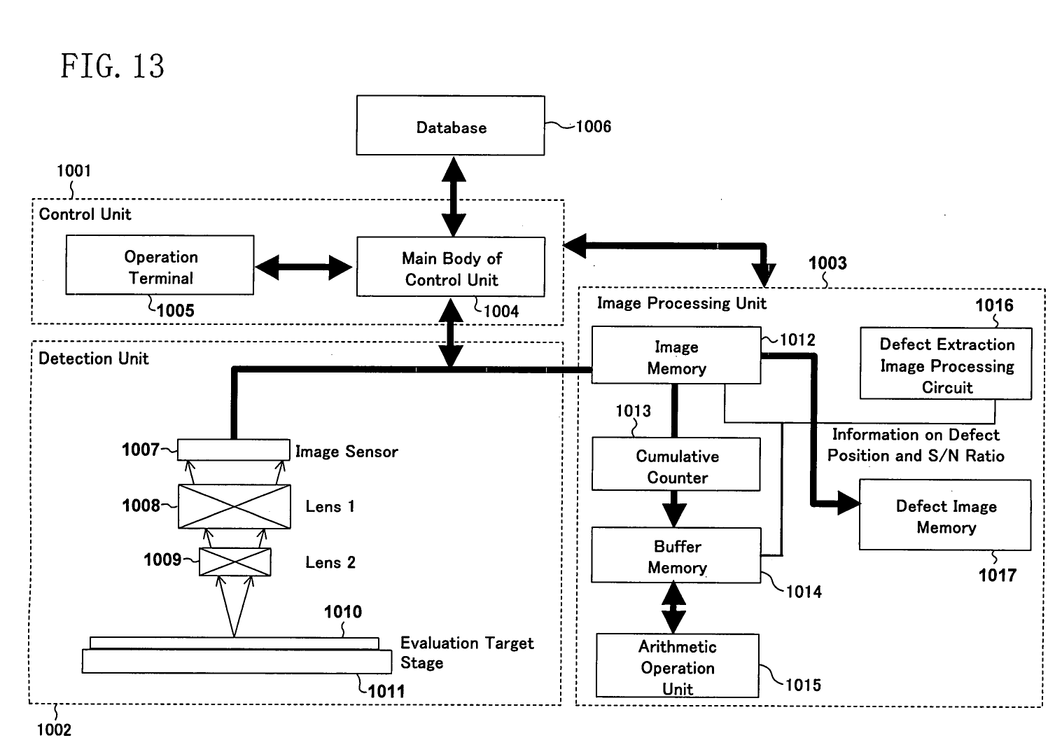

FIG. 13 shows a schematic structure of the defect inspection system according to the fifth embodiment and a data flow therein. As shown in FIG. 13, the structure of the defect inspection system (defect inspection apparatus) according to the present embodiment is roughly divided into a control unit 1001, a detection unit 1002, and an image processing unit 1003. The control unit 1001 is composed of a main body 1004 of the control unit for performing system control and an operation terminal 1005 through which an operator issues an instruction or checks data on the result of a defect inspection. The detection unit 1002 is composed of, e.g., an image sensor 1007 and lenses 1008 and 1009 each for detecting a projection image obtained by irradiating an evaluation target 1010 placed on a stage 1011 with a light beam or the like.

Image signals obtained by the image sensor 1007 are successively transferred to the image memory 1012 of the image processing unit 1003. In the image processing unit 1003, such processes as image comparison and image filtering are performed by a defect extraction image processing circuit 1016 with respect to the image signals. Data determined as a defect is accumulated in a defect image memory 1017. At the same time, the image data signals transferred to the image memory 1012 are transformed by a cumulative counter 1013 to data indicative of the relationship between the signal intensity and the number of detected signals (frequency) or the cumulative number of detected signals (cumulative frequency). The data resulting from the transformation is accumulated as signal distribution data in a buffer memory 1014. An arithmetic operation unit 1015 further performs logarithmic transformation and cube root transformation with respect to the cumulative frequency data accumulated in the buffer memory 1014 and the results of the transformations are stored in the buffer memory 1014.

In a sampling inspection according to the present embodiment, which will be described later, a defect detection threshold is automatically set by using the transformation data stored in the buffer memory 1014.

A S/N ratio is calculated for each of defects detected in a substantial inspection according to the present embodiment, which will be described later, and the result of the calculation is added as defect information to the defect image memory 1017. As the defect information, the positions of the defects, the sizes thereof, the types thereof, the S/N ratios thereof, and the like are accumulated in a database 1006. The signal distribution data obtained as a result of the data transformations described above is also accumulated in the database 1006.

A description will be given herein below to the defect inspection method, the S/N ratio evaluation method, and the inspection operation each using the defect inspection system according to the present embodiment shown in FIG. 13.

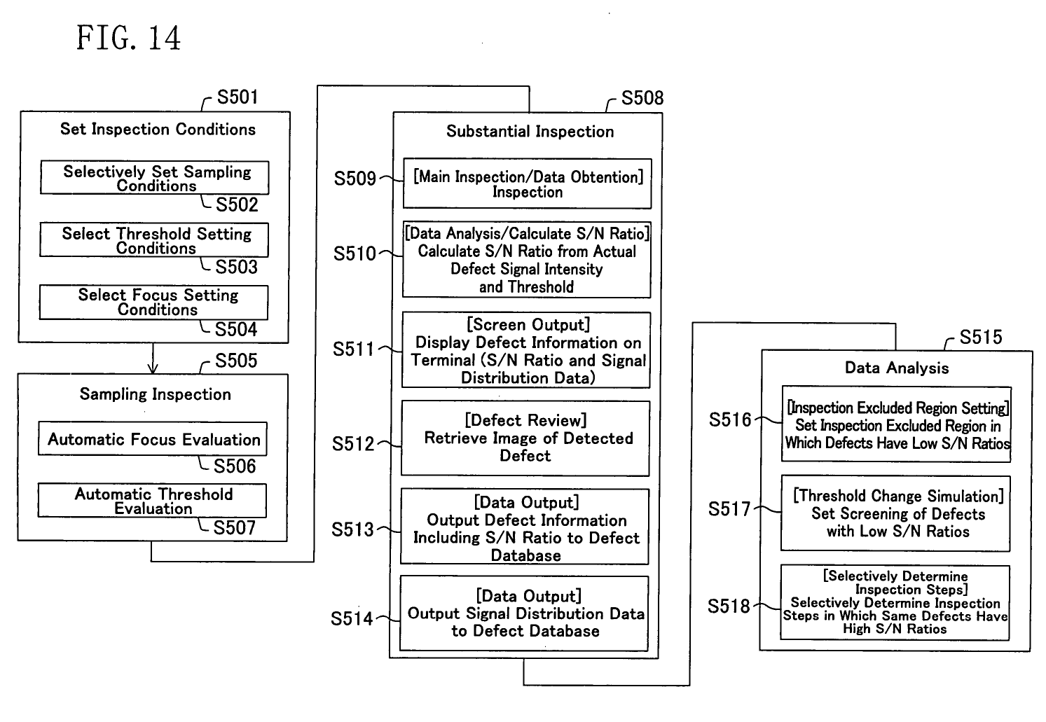

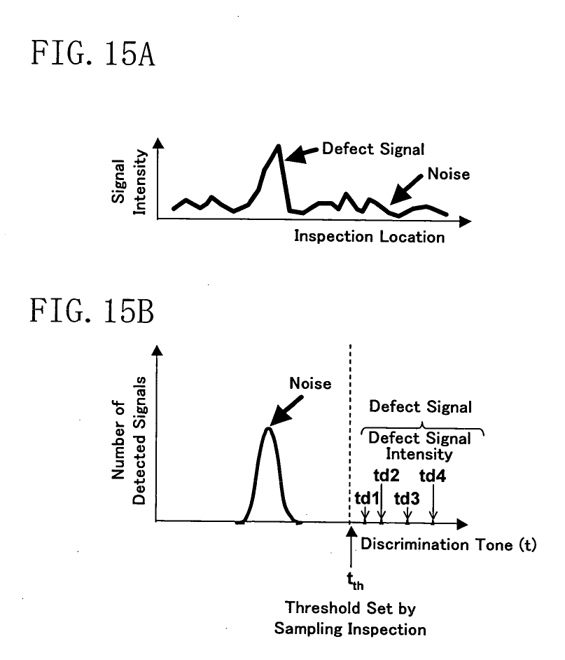

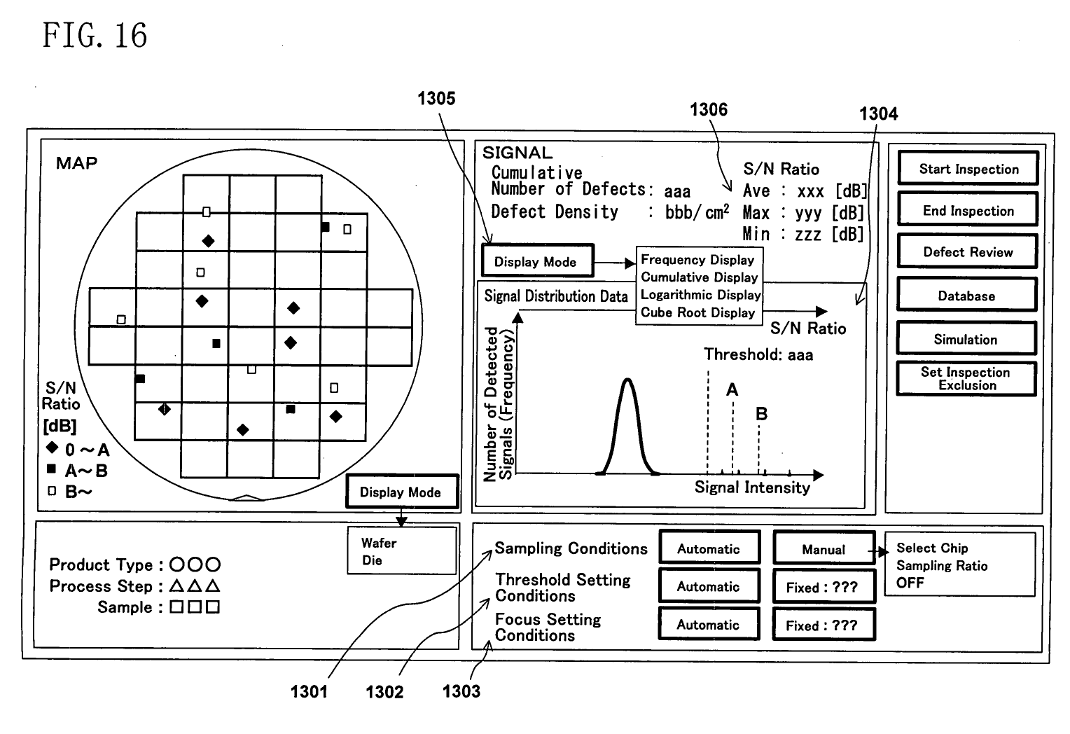

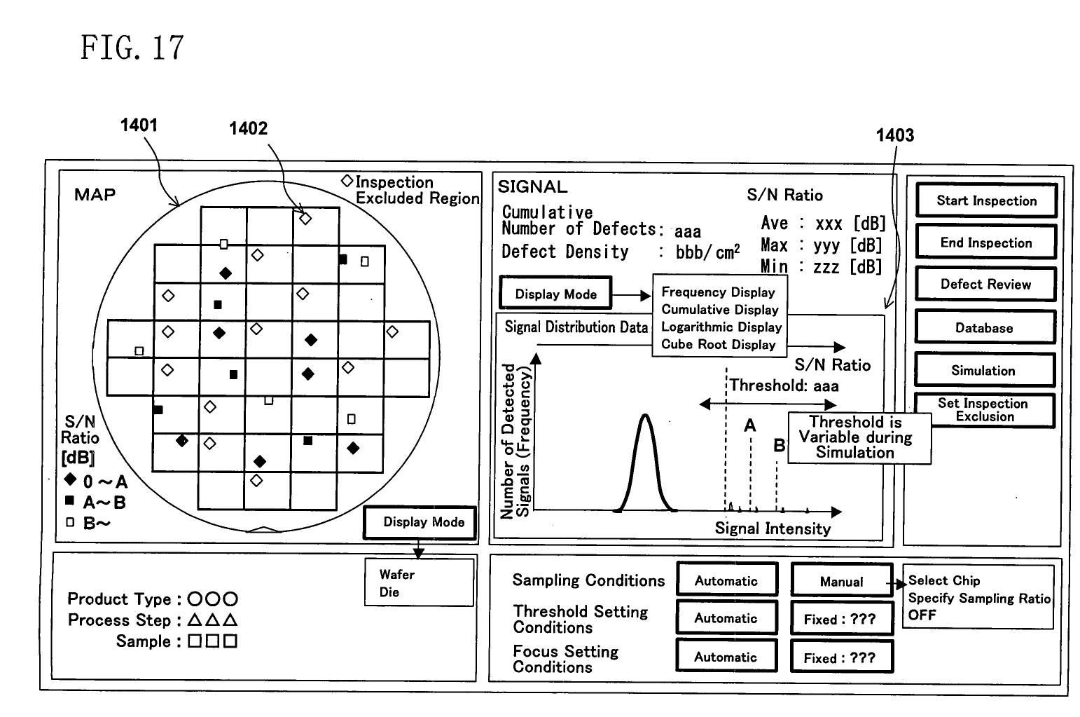

FIG. 14 shows the process flow of the defect inspection method according to the present embodiment. FIGS. 15A and 15B are views each for illustrating the S/N ratio evaluation method (data analysis method) according to the present embodiment. FIGS. 16 and 17 are views each for illustrating the inspection operation according to the present embodiment.

First, in Step S501, the setting of inspection conditions is performed. Specifically, first in Step S502, conditions for a sampling inspection are set by selecting, e.g., sampling conditions 1301 in a screen displayed on the operation terminal 1005 as shown in FIG. 16. Examples of options for the sampling conditions 1301 shown in FIG. 16 include “Automatic” and “Manual”. When “Automatic” is selected, chips to be inspected or regions to be inspected are automatically set impartially to, e.g., the surface of a substrate to be inspected in consideration of an inspection time. When “Manual” is selected, on the other hand, the operator is allowed to individually set the chips to be inspected or selectively determine not to perform a sampling inspection.

Next, in Step S503, threshold setting conditions are selected. Specifically, it is selectively determined whether the threshold is to be automatically set by the sampling inspection described in the first embodiment or the threshold is to be given in advance by selecting, e.g., threshold setting conditions 1302 in a screen as shown in FIG. 16. It is assumed herein that the threshold automatic setting according to the first embodiment is selected.

Next, in Step S504, focus setting conditions are selected. Specifically, it is selectively determined whether a focus value is automatically set by the sampling inspection described in the second embodiment or whether a focus value is given in advance by selecting, e.g., focus setting conditions 1303 in a screen as shown in FIG. 16. It is assumed herein that the automatic focus setting according to the second embodiment is selected.

Next, in Step S505, the sampling inspection is performed. In the sampling inspection, the sampling region set to the surface of the substrate to be inspected in Step S502 is irradiated with an energy beam and the energy beam reflected from the sampling region is obtained as an image signal. Specifically, an automatic focus evaluation is performed first in Step S506. The content of the automatic focus evaluation is as follows. It is assumed in the present embodiment that the substrate to be inspected is irradiated with a light beam and the light beam reflected from the substrate to be inspected is obtained as the image signal. First, an initial focus is set by optical focusing in the same manner as set by the prior art technology. Next, the automatic focus setting according to the present invention (see the second embodiment) is performed. At this time, the focus is upwardly and downwardly varied each in two levels centering around the initial focus. An amount of variation in the focus is empirically determined based on the scale factor of the inspection. For example, when the scale factor of the inspection is high, i.e., when an extremely small defect is to be detected by reducing a pixel size, the amount of variation in focus is reduced to a value as small as about the pixel size. Then, as described in the second embodiment, a focus value which allows the defect detection threshold to be maximized is evaluated and the maximum value of the defect detection threshold is derived. At this time, if the center of the focus value largely shifts, i.e., if the peak value of noise serving as the optimal focus value is not present between the minimum and maximum values of the focus when the focus is varied as in the case where the maximum value of noise obtained by varying the focus monotonously increases or decreases relative to the focus value, the automatic focus evaluation is performed again as necessary.

Next, an automatic threshold evaluation is performed in Step S507. At this time, when the focus when the automatic focus evaluation is performed in Step S506 is the same as the level value of the varied focus, i.e., when the optimal focus value obtained by performing the automatic focus evaluation coincides with the focus value used when the optimal focus is evaluated, Step S507 may also be skipped. When Step S507 is not skipped, the threshold automatic evaluation in Step S507 is performed again by using the optimal focus value set by the automatic focus evaluation in Step S506 so that the optimal focus value is set again and the defect detection threshold is set. The result of the sampling inspection obtained in Step S505 is displayed in, e.g., signal distribution data 1304 in a screen as shown in FIG. 16. However, since the defect detection threshold has not been set at the time at which the sampling inspection is performed in Step S505, the calculation of the S/N ratio, which will be described later, is not performed and the result thereof is not displayed, either.

Next, in Step S508, the substantial inspection is performed. Specifically, first in Step S509, the main inspection is performed by using the focus value and the threshold each set in the sampling inspection in Step S505. In the main inspection, the substrate to be inspected is irradiated with an energy beam and the energy beam reflected from the substrate is obtained as an image signal. The obtained image signal data is successively accumulated in the image memory 1012 of the image processing unit 1003. At this time, when the intensity of the obtained image signal (digital image signal) exceeds the threshold set in the sampling inspection in Step S505, the signal is detected as a defect, while the number of detected image signal data sets is cumulatively incremented by the cumulative counter 1013 of the image processing unit 1003. As a result, the image data signal is transformed to the data indicative of the relationship between the signal intensity and the number of detected signals (frequency) or the cumulative number of detected signals (cumulative frequency) and the data resulting from the transformation is accumulated as the signal distribution data in the buffer memory 1014. The arithmetic operation unit 1015 further performs the logarithmic transformation and the cube root transformation with respect to the cumulative frequency data accumulated in the buffer memory 1014. The results of the transformations are stored as the signal distribution data in the buffer memory 1014. The signal distribution data stored in the buffer memory 1014 is displayed in, e.g., the signal distribution data 1304 in a screen as shown in FIG. 16. At this time, the content of the display can selectively be determined in, e.g., a display mode 1305 in a screen as shown in FIG. 16.

Next, in Step S510, data analysis is performed by using the transformation data mentioned above so that the S/N ratio is calculated. A description will be given to a method for calculating the S/N ratio with reference to FIGS. 15A and 15B. FIG. 15A shows the signal data (image signal) obtained in the main inspection in Step S509. When the data shown in FIG. 15A is obtained, the data is successively transformed to the cumulative data. FIG. 15B diagrammatically shows the data transformed to the cumulative data for the calculation of the S/N ratio by using a frequency graph. If it is assumed that the threshold set by the sampling inspection in Step S505 is tₜₕ, the intensity (specifically the discrimination tone (t)) of the noise signal is distributed such that tₜₕ has the maximum intensity, as shown in FIG. 15B. Defect signal data is a signal having an intensity higher than tₜₕ and the respective intensities of individual defect signals are, e.g., td1, td2, . . . and tdx. In the present embodiment, SN1, SN2, . . . and SNx as the respective S/N ratios of the individual defect signals are given by (Numerical Expression 17) shown below.
SNx=20 log(tdx/tₜₕ)[dB] (Numerical Expression 17)
The S/N ratios calculated for the individual defects are accumulated as defect information in the defect image memory 1017 of the image processing unit 1003.

At the same time with the calculation of the S/N ratio in Step S510, a screen output is produced in Step S511. Specifically, the number of defects, the defect density, and the mean value, maximum value, and minimum values of the S/N ratio are displayed as defect information in, e.g., a SIGNAL display region 1306 in a screen as shown in FIG. 16. The S/N ratio used herein is a ratio between the defect signal intensity and the defect detection threshold which indicates the detection reliability with which the defect signal is determined as a defect. In other words, the S/N ratio indicates a value showing whether or not conditions for the inspection are valid, i.e., the validity (score) of the conditions for the inspection. Accordingly, by displaying the S/N ratio in the SIGNAL display region 1306 in real time during the substantial inspection, it becomes possible to check in real time whether or not the intensity ratio between the defect signal intensity and the defect detection threshold is sufficiently high, i.e., the authenticity of the inspection result.

Next, in Step S512, a defect review is conducted. The defect review is for retrieving detailed information on an image detected as a defect and thereby checking the presence or absence of a defect or specifying the type of the defect.

Next, in Step S513, data including the conditions for the inspection such as the positions of defects, the sizes thereof, the types thereof, the S/N ratios, and the defect detection threshold is outputted as the defect information to the database 1006. On the other hand, the signal distribution data obtained in the main inspection in Step S509 is outputted in Step S514 to the database 1006. The outputted signal distribution data may be any one of, e.g., the data indicative of the relationship between the signal intensity (discrimination tone) and the number of detected signals (frequency) (see FIG. 2B), the data indicative of the relationship between the cumulative number of detected signals obtained by integrating the number of detected signals with the signal intensity and the signal intensity (discrimination tone) (see FIG. 2C), the data indicative of the relationship between the logarithmically transformed cube-root cumulative number of detected signals obtained by successively performing logarithmic transformation and cube root transformation with respect to the cumulative number of detected signals and the signal intensity (discrimination tone) (see FIG. 2E), the gradient of the linear characteristic of the number of the logarithmically transformed cube-root cumulative number of detected signals relative to the discrimination tone, and the threshold data as the maximum discrimination tone with which the cumulative number of detected signals is less than 1 (see FIG. 2F).

Next, in Step S515, data analysis is performed with respect to the defect information obtained in the substantial inspection in Step S508. Specifically, inspection excluded region setting is performed in Step S516. A description will be given to an example of the data analysis in the inspection excluded region setting with reference to, e.g., a MAP (defect map) 1401 in a screen as shown in FIG. 17 which is displayed on the operation terminal 1005. In the inspection excluded region setting in Step S516, a region to be inspected in which the S/N ratio is lower than a specified value is extracted and the extracted region is set as a region to be excluded. Specifically, defects with low S/N ratios present in, e.g., the same chip region (in-chip coordinates) are extracted. For example, a defect 1402 is shown as one of the defects with low S/N ratios in the MAP 1401 in a screen as shown in FIG. 17. It is checked whether or not such a defect is an actual defect by using the defect review image recorded in the database 1006. Thereafter, the chip region in which the defect 1402 that has proved to be not an actual defect is set as the region to be excluded. As a result, when a defect inspection is performed with respect to a plurality of inspection targets of the same product type, if a region containing a group of patterns in which erroneous detection of a defect is likely to occur or the like is previously set as the region to be excluded based on the result of inspecting one inspection target, the remaining region other than the region set as the region to be excluded can be inspected in the inspection of the other inspection targets. As a result, it becomes possible to set a higher S/N ratio (i.e., a lower defect detection threshold) to the other regions in the inspection and thereby increase the sensitivity of the defect detection.

Next, in Step S517, a threshold change simulation is performed. A description will be given to an example of the data analysis in the threshold change simulation with reference to, e.g., a signal distribution data (graph) 1403 in a screen as shown in FIG. 17. In the threshold change simulation in Step S517, the defect detection threshold is changed by using software based on the inspection result already obtained (e.g., the S/N ratio calculated in Step S510) and the screening of a defect is performed. Specifically, the defect information and the signal distribution data are retrieved first from the database 1006 recording therein the defect information and the like. An example of the retrieved data is shown in, e.g., the MAP 1401 and the signal distribution data 1403 in a screen as shown in FIG. 17. Then, the threshold change simulation is performed. In the setting of the simulation, the threshold shown in the signal distribution data 1403 becomes variable and the number of defects, the defect density, the S/N ratio, or the like or, alternatively, the defect distribution shown in the MAP 1401 is changed as the threshold is changed. It is also checked whether or not a defect newly detected by changing the threshold is an actual defect by using the defect review image recorded in the database 1006. This makes it possible to perform easy checking of the usability of the defect data accumulated in the database 1006 and easy screening of the defect, while checking the S/N ratio indicative of the authenticity of the defect, without actually performing the measurement (main inspection) again. As a result, the defect detection threshold can be set again with high accuracy.

Next, in Step S518, inspection steps are selectively determined. Specifically, when the results of a plurality of steps of the main inspection that have been performed with respect to the same inspection target are accumulated in the database 1006, the steps of the main inspection having higher sensitivities to a given defect type are selectively determined. That is, when the results of the plurality of steps of the main inspection that have been performed with respect to the same inspection target are accumulated in the database 1006 and when a defect has been detected from the same portion by at least two or more of the steps of the main inspection, the S/N ratios of the defects (included in the defect information) detected from the same portion in the two or more steps of the main inspection are compared with each other, whereby one or more of the steps of the main inspection in which the S/N ratio of the defect is relatively high are picked up. This allows the extraction of the step or steps of the main inspection having higher defect detection sensitivities to an arbitrary defect type.

Thus, according to the fifth embodiment, even when the defect density in an inspection target is particularly low or the ratio between the defect signal and the noise signal is particularly low, the defect detection threshold can be set with high accuracy in a short time based on the maximum intensity of the noise signal from the substrate to be inspected by evaluating the noise signal including color unevenness in the substrate to be inspected and the like. As a result, the possibilities of the erroneous detection of a defect and the missing of a defect can be minimized and inspection variations can be reduced.

In each of the first to fifth embodiments, the principle of the defect inspection is not particularly limited.

Specifically, an inspection input signal (the energy beam with which the inspection target is irradiated) may be an electron beam, an optical system (a laser beam, a lamp beam, or the like), an X-ray beam, an infrared beam, a magnetic field, or the like. An output signal (the energy beam reflected from the inspection target) may be a light beam such as a reflected beam, a scattered beam, or an interference beam, an electron beam such as secondary electrons, reflected electrons, transmitted electrons, or absorbed electrons, a radioactive beam such as an a beam, a γ beam, or an X-ray beam, or the like. By applying the defect inspection according to each of the embodiments to a digital image signal obtained by detecting the output signal, converting the detected output signal to an image signal, and performing A/D conversion with respect to the converted image signal, it becomes possible to obtain the same effects as achieved by each of the embodiments. The same effects are achievable even when the digital image signal is either an unprocessed image signal or a differential image signal.

Although the structure of the defect inspection system according to the fifth embodiment has been described by using the case where the optical-system detector is used as an example, the same effects are achievable even when the detector for an electron beam, a radioactive beam, or the like is used in place of the optical-system detector.

In each of the first to fifth embodiments, the same effects are achievable even when a pattern exists or does not exist on the inspection target.

When the sampling inspection (preparatory inspection) and the substantial inspection are performed in the fifth embodiment, it is also possible to exclusively set a range to be inspected in the sampling inspection and a range to be inspected in the substantial inspection. The arrangement prevents the inspection from being performed with respect to the region inspected in the sampling inspection more than once so that it becomes possible to circumvent damage caused by an electron beam or the like to the region inspected in the substantial inspection. Since the region inspected in the sampling inspection barely contains defects as described in the first embodiment, the exclusion of the region inspected in the sampling inspection from the region inspected in the substantial inspection hardly affects the results (the defect density, the number of defects, and the like) of inspecting the entire inspection target.

When a pattern exists on the inspection target in the fifth embodiment, it is preferable that the region to be inspected in the sampling inspection impartially includes the pattern, that the ratio of the area of the region inspected in the sampling region to the area of the entire inspected region is not less than 1/100 and not more than 1/10, and that the region inspected in the sampling region is evenly distributed over the entire inspected region. This allows high-accuracy and short-time setting of the defect detection threshold. In this case, the region to be inspected in the sampling inspection is preferably set in a striped configuration or in an array-like configuration.

In the fifth embodiment, it is also possible to display the S/N ratio calculated in Step S510 for each of the defects detected in the main inspection in Step S509 during the main inspection or after the completion thereof. Alternatively, it is also possible to calculate the S/N ratio for each of the minimum value, mean value, and maximum value of the intensity of a digital image signal detected as a defect in the main inspection in Step S509 and display each of the S/N ratios during the main inspection or after the completion thereof. Alternatively, it is also possible to display the correlations between the number of the digital image signals detected as defects in the main inspection in Step S509, the cumulative number thereof or the logarithmically transformed cube-root number thereof and the intensities of the digital image signals during the main inspection or after the completion thereof. The arrangement allows the difference between a noise signal and a defect signal to be recognized even during the inspection and thereby allows real-time checking of the authenticity of the inspection result. In short, the erroneous detection of a defect resulting from noise or the like can promptly be sensed.

In the fifth embodiment, it is also possible to calculate the S/N ratios of defects detected in the defect inspection of a plurality of inspection targets each having the same structure and determine the validities of the detected defects based on the difference between the respective S/N ratios of the individual inspection targets.

What is claimed is:

1. A defect inspection method comprising the steps of:
irradiating a substrate to be inspected with an energy beam to obtain the energy beam reflected from the substrate to be inspected as a digital image signal; and
detecting the digital image signal as a defect when an intensity of the obtained digital image signal exceeds a threshold, wherein
the threshold is set based on a maximum intensity of a noise signal included in the digital image signal.

2. The defect inspection method of claim 1, further comprising the steps of:
obtaining the intensity of the noise signal from a specified inspected region of the substrate to be inspected as a discrimination tone;
determining a number of the noise signals that have been detected for the discrimination tone;
calculating a cumulative number of the detected noise signals by integrating the number of the detected noise signals with the discrimination tone;
performing logarithmic transformation with respect to the cumulative number of the detected noise signals by using a normal distribution characteristic of the noise signal and calculating a cube root of the logarithmically transformed cumulative number of the detected noise signals as a logarithmically transformed cube-root cumulative number of the detected noise signals; and
calculating a maximum value of the discrimination tone with which the cumulative number of the detected noise signals is less than 1 based on a linear characteristic of the logarithmically transformed cube-root cumulative number of the detected noise signals for the discrimination tone and setting the calculated value to the threshold.

3. The defect inspection method of claim 2, wherein
the digital image signal is obtained from the substrate to be inspected by each of a plurality of detection systems,
the number of the detected noise signals, the cumulative number of the detected noise signals, the logarithmically transformed cube-root cumulative number of the detected noise signals, and the threshold are calculated for each of the plurality of detection systems, and
an offset value is set to each of the thresholds such that the respective thresholds calculated for the plurality of detection systems have the same values, while a coefficient is set to each of gradients of straight lines representing respective linear characteristics of the logarithmically transformed cube-root cumulative number of the detected noise signals calculated for the plurality of detection systems for the discrimination tone such that the straight lines have the same gradients.

4. The defect inspection method of claim 2, wherein
the digital image signal is obtained for each value of a parameter of the energy beam by varying the value of the parameter,
the number of the detected noise signals, the cumulative number of the detected noise signals, the logarithmically transformed cube-root cumulative number of the detected noise signals, and the threshold as the maximum discrimination tone with which the cumulative number of the detected noise signals is less than 1 are calculated for each value of the parameter, and
the value of the parameter which allows the threshold to be maximized is determined based on the threshold calculated for each value of the parameter.

5. The defect inspection method of claim 4, wherein
the digital image signal is obtained from the substrate to be inspected for each value of the parameter by each of a plurality of detection systems,
the number of the detected noise signals, the cumulative number of the detected noise signals, the logarithmically transformed cube-root cumulative number of the detected noise signals, and the threshold as the maximum discrimination tone with which the cumulative number of the detected noise signals is less than 1 are calculated for each value of the parameter for each of the plurality of detection systems,
the value of the parameter which allows the threshold to be maximized is calculated for each of the plurality of detection systems, and
an offset value is set to each of the values of the parameter such that the parameter which allows the threshold to be maximized that has been calculated for each of the plurality of detection systems has the same value.

6. The defect inspection method of claim 4, wherein
the parameter is a focus or a wavelength when the energy beam is a light beam and
the parameter is a focus provided by an electronic lens, an acceleration energy, or an energization current when the energy beam is an electron beam.

7. A defect inspection method comprising the steps of:
irradiating a substrate to be inspected with an energy beam to obtain the energy beam reflected from the substrate to be inspected as a digital image signal; and
detecting the digital image signal as a defect when an intensity of the obtained digital image signal exceeds a threshold, the defect inspection method further comprising:
a sampling inspection step of performing a sampling inspection with respect to a specified inspected region of the substrate to be inspected and setting the threshold based on a maximum intensity of a noise signal included in the digital image signal obtained as a result of the sampling inspection; and
a main inspection step of performing a main inspection with respect to the substrate to be inspected and detecting the digital image signal as a defect when the intensity of the digital image signal obtained as a result of the main inspection exceeds the threshold set in the sampling inspection step.

8. The defect inspection method of claim 7, wherein
when a pattern exists on the substrate to be inspected, the specified inspected region impartially includes the pattern,
a ratio of an area of the specified inspected region to an area of the entire inspected region of the substrate to be inspected is not less than 1/100 and not more than 1/10, and
the specified inspected region is evenly distributed over the entire inspected region.

9. The defect inspection method of claim 8, wherein the specified inspected region is set in a striped configuration or in an array-like configuration.

10. The defect inspection method of claim 7, wherein a S/N ratio between the intensity of the digital image signal detected as the defect in the main inspection step and the maximum intensity of the noise signal is calculated such that the threshold is set again based on the calculated S/N ratio and a defect is extracted again by using the digital image signal obtained by the main inspection and the threshold set again without newly performing the main inspection.

11. The defect inspection method of claim 7, wherein
a S/N ratio between the intensity of the digital image signal detected as the defect in the main inspection step and the maximum intensity of the noise signal is calculated and the calculated S/N ratio is displayed for each of the defects detected in the main inspection step during the main inspection step or after a completion thereof,
a S/N ratio between each of a minimum value of the intensity of the digital image signal detected as the defect in the main inspection step, a mean value thereof, and a maximum value thereof and the maximum intensity of the noise signal is calculated and each of the calculated S/N ratios is displayed during the main inspection step or after the completion thereof, or
a correlation between a number of the detected digital image signals each detected as the defect in the main inspection step, a cumulative number of the detected digital image signals, or a logarithmically transformed cube-root cumulative number of the detected digital image signals and the intensity of the digital image signal is displayed during the main inspection step or after the completion thereof.

12. The defect inspection method according to claim 7, further comprising the step of:
before the main inspection step, preliminarily extracting a region in which a S/N ratio between the intensity of the digital image signal and the maximum intensity of the noise signal is lower than a specified value and setting the extracted region as an excluded region, wherein
the main inspection step includes performing the main inspection with respect to a remaining region other than the excluded region in the substrate to be inspected.

13. The defect inspection method of claim 7, wherein
the main inspection step is performed a plurality of times,
a S/N ratio between the intensity of the digital image signal detected as the defect in each of the main inspection steps and the maximum intensity of the noise signal is calculated, and
a comparison is made between the respective S/N ratios that have been calculated for an arbitrary defect in the individual main inspection steps such that one or more of the main inspection steps in each of which the S/N ratio is relatively high are extracted.
